(19) United States
(12) Patent Application Publication
(10) Pub. No.: US 2024/0217834 A1
(43) Pub. Date: Jul. 4, 2024

(54) BIOMATERIALS FROM BIOCARBONATES

(71) Applicant: Ginn IP, LLC, Sandersville, GA (US)

(72) Inventors: Michael Warren GINN, Sandersville, GA (US); Whitney Lynn JONES, Mitchell, GA (US); Hodges Truman WILLIS, Sandersville, GA (US)

(73) Assignee: Ginn IP, LLC, Sandersville, GA (US)

(21) Appl. No.: 18/392,449

(22) Filed: Dec. 21, 2023

Related U.S. Application Data
(60) Provisional application No. 63/434,551, filed on Dec. 22, 2022.

(51) Int. Cl. C01F 11/18; C09D 1/00

(52) U.S. Cl. CPC C01F 11/18; C09D 1/00

(57) ABSTRACT

Unique biocarbonates and/or biominerals obtained from all avian eggshells, snail shells, oyster shells, and/or seashells with customized particle size, different morphologies, and/or superior brightness as compared to natural calcium carbonates. Method and system of producing and using the unique biocarbonates and/or biominerals for various applications, e.g., paints, papers, plastics, and/or coatings.

### CROSS-REFERENCE TO RELATED APPLICATIONS

This application claims the priority and benefit of U.S. Provisional Application No. 63/434,551, filed on Dec. 22, 2022, the content of which is incorporated by reference in its entity.

### FIELD AND BACKGROUND

The present disclosure relates generally to Earth Circle Technologies (ECT) BioMinerals. Particularly, the present disclosure provides biomaterials from naturally occurring biocarbonates, and methods of producing and using thereof.

A BioCarbonate is a commercial/scientific term, as defined by ECT BioMinerals, to represent a biomineral resource/product containing greater than 50% calcium carbonate, designed and engineered by living organisms creating a range of sustainable, environmental, and commercial attributes including novel and existing applications. Examples of global commercial sources of BioCarbonates include, but are not limited to, all avian eggshells (such as chicken, turkey, and duck, see e.g., FIG. 1), snail shells, oyster shells and most seashells. All naturally occurring biocarbonates are biominerals, defined as natural composite materials based upon biomolecules (such as proteins) and minerals produced by living organisms via processes known as biomineralization, yielding materials with impressive mechanical properties such as bones, shells, and teeth (Oxford, 2022).

Chicken egg production over the last decade has surged ˜18%, with China, USA and India being the primary producers. Biocarbonates, specifically the chicken eggshell variety, represent approximately 8.5 million metric tons of calcium-rich waste across the globe annually, most of which ends up in landfills, creating environmental issues. As shown in FIGS. 2, 3, and 4, approximately 10% of the weight of an egg is its porous shell. Approximately 94-97% of the shell is pure calcium carbonate (CaCO₃). Instead, this resource can be utilized to produce valuable, sustainable biomaterials useful in a wide variety of fields and applications using the method described herein. Due to the vast availability and potential for reuse, chicken eggshells have been the primary resource of choice for all work contained herein, although all sources of BioCarbonates could be used.

The main resource varieties for eggshells are those white in color, brown, and blends. Most of these resources still contain the attached membrane, which primarily consists of protein (see e,g. FIG. 5).

Eggshell waste producers grow, design and bioengineer high quality/sustainable bioresources, such as calcium carbonate from the chicken and egg commercial cycle. ECT BioMinerals has proven that eggshells can be transformed into a range of valuable products including BioFillers/BioCoatings/BioPigments as well as functional/PreCursor Materials and NanoReactors.

The products and materials that are recovered, designed, and engineered are: valuable, sustainable, post-consumer/industrial, recycled, green/eco-friendly, and renewable.

### SUMMARY

The present disclosure provides biomaterials from biocarbonates and a method of producing and using thereof. Through a variety of processing options that can be custom-employed depending upon the final application use, the present disclosure provides a system that collects/sorts/blends the unique bioresource with a unique calcium carbonate mineral structure, liberates and separates the membrane and shell while providing sterilization and odor elimination (if desired), customizing particle size and brightness and filtering/drying the biomaterial into multiple product form options. The biomaterials disclosed herein are biominerals and/or biocarbonates, and can be used as bioresources, biofillers, biocoatings, bioprecursors, nano-biofillers and/or nano-biocoatings etc. for various applications, including but not limited to paint/coating and plastics. In addition, valuable co-products from protein sources of albumin and membrane add additional value.

### BRIEF DESCRIPTION OF THE DRAWINGS

Many aspects of the present disclosure can be better understood with references to the drawings presented herein. The components in the drawings are not necessarily to scale, emphasis instead being placed upon clearly illustrating the principles of the present disclosure. Moreover, in the drawings, like reference numerals designate corresponding parts throughout the several views.

FIG. 1 (Prior Art). Examples of BioCarbonate Resources.

FIG. 2(Prior Art). Anatomy of a Chicken Egg. A chicken egg composes of 1) Shell made of calcium carbonate—same material as sea shells, chalk, and limestone. Porous vet protective—moisture and air can pass through the shell; 2) Inner & Outer Shell Membranes, made of protein—prevents bacterial infection: 3) White (Albumen), made of protein and water, protects the yolk; 4) Yolk, made of fat, protein, cholesterol, water, vitamins, minerals, also contains lecithin, which is used as an emulsifier: 4) Chalaza, protein stands—suspend yolk in the white; and Air Cell forms when the egg contracts as it cools after laving. Freshness indicator—air cell gets bigger as moisture leaves the egg.

FIG. 3 (Prior Art). Scanning Electron Micrograph of Porous Eggshell—Sideshell.

FIG. 4 (Prior Art). Scanning Electron Micrograph of Porous Eggshell.

FIG. 5 (Prior Art). BioCarbonate Resources Examples.

FIG. 6. Four-stage Integrated System.

FIG. 7. Step I Setup (Log Washer/Functionality).

FIG. 8. Step II Setup (Autogenous Grinding/Liberation/Separation in Small Double Cell Attrition Grinder/No Media).

FIG. 9. Step III Setup (High Shear Mixing/Hydro-Separator).

FIG. 10. Basic Transformational Flowsheet. For ultra-high brightness products and/or niche markets. Technical options: membrane liberation, separation, and removal process. Dry options (material must be air or bone dried): liberation, crushing, milling, shedding etc. (fine as possible): separation, air-classified, air swept, fluidized bed, etc. Membrane separation could be wet or dry.

FIG. 11. Fully Integrated Transformational Flowsheet.

FIG. 12. System 1 and 2 Flowsheet options.

FIG. 13. Alternative System 1 (System 1A. Wet technology) & 2 (System 1B, Dry technology) Flowsheet options.

FIG. 14. System 1 (1-2 TPH Membrane Separation Operation and Plant Design).

FIG. 15. System 2 (1-2 TPH Pigment and Filler Operation and Plant Design).

FIG. 16. System 3 (Plan View of the Integrated Operation Design).

FIG. 17. Final Product Brightnesses from eggshell resources.

FIG. 18. Product Qualities and Specifications.

FIG. 19. Wet-ground product/particle morphologies (SEM). Sphericity=normal diameter/maximum intercept. Roundness=average radius of corners and edges/radius of maximum inserted circle.

FIG. 20-1 (prior art). Applications list & U.S. Paints & Coatings Markets (2016-2027). FIG. 20-2 (prior art). Global Paints & Coatings Market showing market size (in 2019 and 2030) and market growth rate (2020-2030).

FIG. 21. Hydrous Processing Flowsheet.

FIG. 22. Calcium Oxide Processing Flowsheet.

FIG. 23. Chemistry Comparison of Fresh Shell Resource and Dried, Aged Shell Resource.

FIG. 24. Air Classification Simulation Results.

FIG. 25. Sterilization treatment—Assisted Membrane Liberation/Separation.

FIG. 26. Large Sample Production Heat-Only Results.

FIG. 27. Post calciner particle size (RoTap).

FIG. 28. Post calciner, post hammermilled particle size average.

FIG. 29. Brightness Optimization Results Graph—Combined Comparison.

FIG. 30. Pulverization Effects on Brightness.

FIG. 31. Treatment Options Effects on Brightness—Point Change Comparison.

FIG. 32. Sterilization Effects on Brightness—PAA Sterilization Effects on TAPPI Brightness.

FIG. 33. Sterilization Effects on ΔBrightness—PAA Sterilization Effects on TAPPI Brightness Change.

FIG. 34. Heat treatment with Agitation Effects on Brightness—BioMinerals Thermal Profile—Material Agitation Comparison.

FIG. 35. Nano-Etching.

FIG. 36. Additional Treatment Options Effects on Brightness—Point Change Comparison.

FIG. 37. Flux Rate Effect on Brightness.

FIG. 38. Wet Ground Particle Size Results—Cumulative Finer Mass Percentage vs Diameter. 1-4 #77M.SMP:BioCarbonate Grind (1:4 beads) 77.5 min Grind 6 #/ion

FIG. 39. Wet Ground Particle Size Results Overlay—Cumulative Fine Mass Percentage vs Diameter. Testing Samples: OMYA-FL.1. SMP:OmyaCarb F-FL reference material Unit 1 test: OCREF-2.SMP:OmyaCarb F-FL reference material Unit 2 test; BATCH3.SMP:BioCarbonate Batch 3 (1:4 beads) 60% Solid 50 min:BATCH4.SMP:BioCarbonate Batch 4 (1:4 beads) 60% Solid 50 min; BATCH9.SMP:BioCarbonate Batch9 (1:4 beads) 60% Solid 90 min; GR-B7.SMP:BioCarbonate Batch7 (1:4 beads) 60% solid 85 min; B12R4.SMP:BioCarbonate B12 Retest (1:4 beads) 60% Solid 80+ min; BATCH6.SMP; 5 (1:4 beads) 60% Solid 50 min:BATCH8.SMP: BioCarbonate Batch 8 (1:4 beads) 60% Solid 90 min.

FIG. 40. Paint Trial Results, Part 1.

FIG. 41. Paint Trial Results, Part 2.

FIG. 42. TGA overlay of GMT-RCarbonate and generic calcium carbonate.

FIG. 43. DSC overlay of GMT-RCarbonate and generic calcium carbonate.

FIG. 44. Tear Strength (gf) Results Comparison at 15% let down.

FIG. 45. Tear Strength (gf) Results Comparison at 30% let down.

FIG. 46 Tensile strength at yield (psi) comparison at 15% let down.

FIG. 47. Tensile strength at yield (psi) comparison at 30% let down.

FIG. 48. Modulus comparison at 15% let down.

FIG. 49. Modulus comparison at 30% let down.

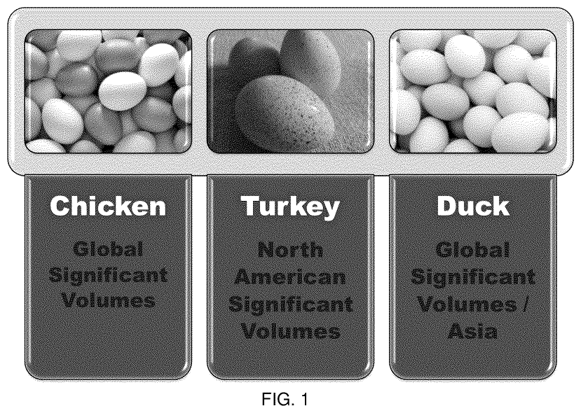

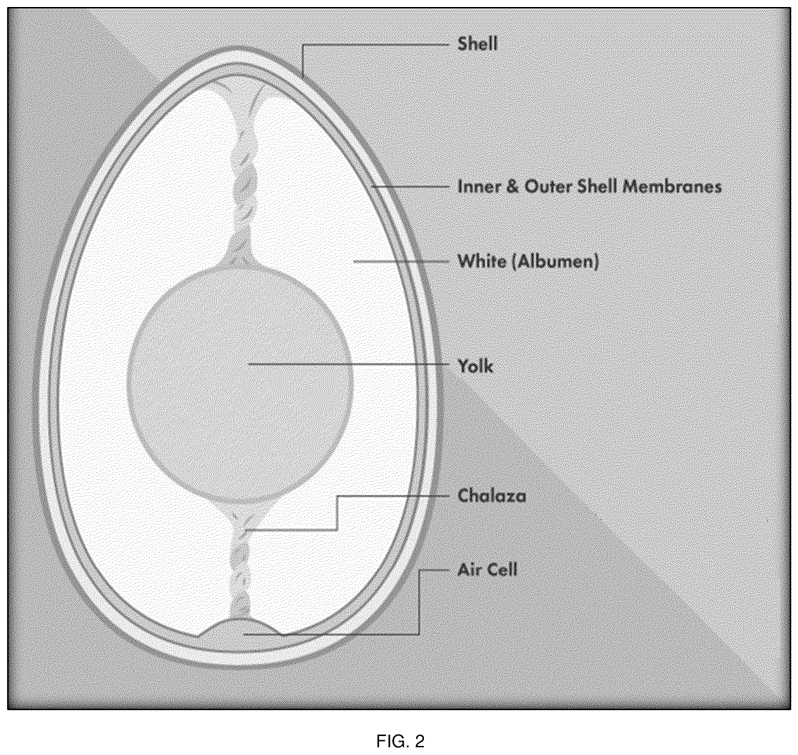

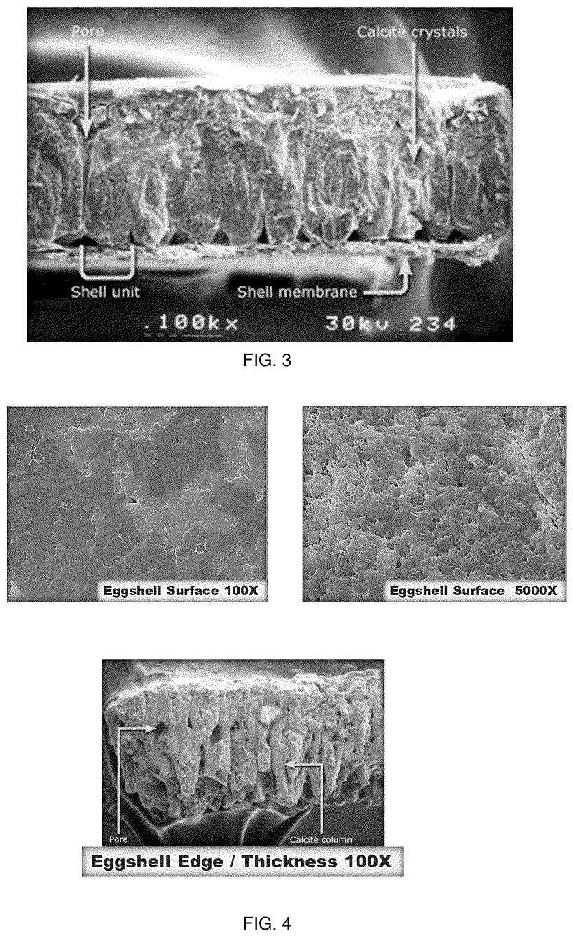

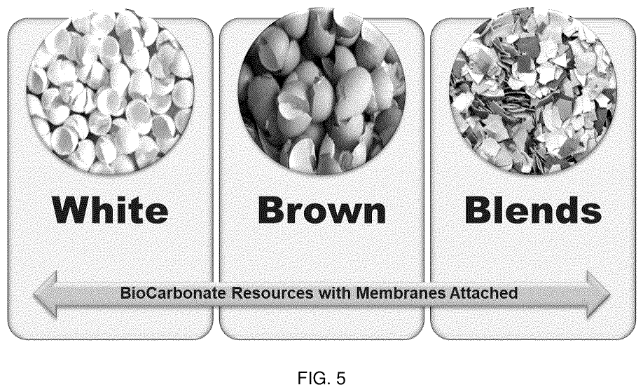

### DETAILED DESCRIPTIONS

The present disclosure provides a system that collects/sorts/blends the unique bioresource mainly from all avian eggshells, snail shells, oyster shells, and/or most seashells, liberates and separates the membrane and shell while providing sterilization and odor elimination (if desired), customizing particle size and brightness and filtering/drying the biomaterial into multiple product form options. The present disclosure also provides the biomaterials obtained through the system of the present disclosure, such biomaterials are biominerals and/or biocarbonates, and can be used as bioresources, biofillers, biocoatings, bioprecursors, nano-biofillers and/or nano-biocoatings etc. for various applications, including but not limited to paint/coating and plastics.

Additional advantages of the present disclosure will be set forth in part in the description which follows, and in part will be obvious from the description, or can be learned by practice of the present disclosure. The descriptions of the embodiments is merely exemplary in nature and is in no way intended to limit the present disclosure, its application, or uses. Although specific terms are employed herein, they are used in a generic and descriptive sense only and not for purposes of limitation.

It is to be understood that the terminology used herein is for the purpose of describing certain aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a short chain fatty acid,” “a carnitine derivative,” or “an adjuvant,” includes, but is not limited to, combinations of two or more such short chain fatty acids, carnitine derivatives, or adjuvants, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

It should be emphasized that the following disclosures are put forth so as to provide those of ordinary skill in the art with a complete disclosure and description of how the composition of matter, e.g., the contact adhesive in this disclosure, and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

Non-limiting examples of resource collection locations include egg breakers, egg stations, chicken hatcheries, egg processing plants, industries, and residential homes. The resource(s) may be from single waste streams or blended and may be customized based on desired final attributes, especially brightness.

An exemplary embodiment of the present disclosure is a system for and method of (1) sorting and blending the unique biocarbonate, (2) removing the albumin and/or membrane from the shell, (3) sterilizing and eliminating odor from the biomaterial and (4) creating a final product for multiple end uses/applications. Collected albumin and/or membrane can be discarded or concentrated for other applications for additional product streams.

In another exemplary embodiment, the system and method are configured to separate the membrane from the shells through an autogenous grinding step that can be chemically aided, where the shells are reduced in size and membranes are effectively liberated and separated by floating via density differences.

In another exemplary embodiment, the separated albumin and/or membrane is recovered for other product streams while simultaneously recycling waste water.

In another exemplary embodiment, the system and method are configured to sterilize and eliminate odor using options such as bleach, sodium hydrosulfite, hydrogen peroxide, biocide, acetic acid, strong acids, acetone, ammonia, ozone, etc. while wet grinding the biomaterial using grinding media to the particle size for the desired application.

In another exemplary embodiment, the system and method are configured to sterilize and eliminate odor using options such as bleach, sodium hydrosulfite, hydrogen peroxide, biocide, acetic acid, strong acids, acetone, ammonia, ozone, etc. and then dry grind the material to the particle size for the desired application.

In another exemplary embodiment, the system and method's configuration are application-specific to nano-etch the biomaterial, allowing it to effectively be flocculated for improved filtration efficiency and drying.

In another exemplary embodiment, the system and method's configuration are applications-specific to soft-dry, pulverize and hard dry the material for further processing. In another exemplary embodiment, the dried biomaterial is surface coated for application-specific needs.

In another exemplary embodiment, further brightness processing such as bleaching, leaching and thermal processing with carbonation can be performed to improve overall brightness.

In another exemplary embodiment, the system and method are configured so that the resource is thermally processed to produce a high brightness biomaterial and carbonated to produce calcium carbonate (CaCO₃), which can further undergo particle sizing and/or coating as the end use application requires.

For brightness-dependent applications, these methods can eggshell biomaterials with a brightness ranging from about 88-97. Particle size is customizable and can range as far down as 90%<2 μm to nano scale. Final calcium carbonate compositions are very high in the ˜95-97% range, often superior in purity to natural resource carbonates.

The potential applications for biomaterials as globally-available, renewable substitutes for any currently-used calcium carbonate product are numerous, including catalysts, nano reactors, drug delivery, bioceramics, biomaterial precursors, paint/coatings and plastics.

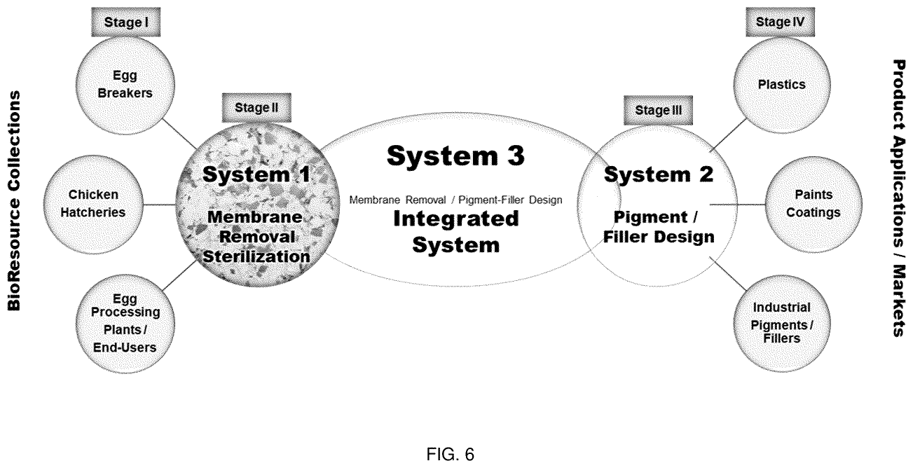

This novel bio resource can be processed to produce any specified particle size and produced in a variety of product forms to suit any given calcium carbonate need on the market. This resource is not only post-consumer, but the supply is almost endless, available worldwide, and consistent. The process transformation stages are shown in FIG. 6 and include: Stage I—BioResource Collection: white/brown/blend, Stage II—Membrane/Eggshell Liberation and Sterilization (Dry vs. Wet), Stage III—Processing Transformation (Dry vs. Wet), Stage IV—Product and Applications Design (Paints/Coating/Plastics).

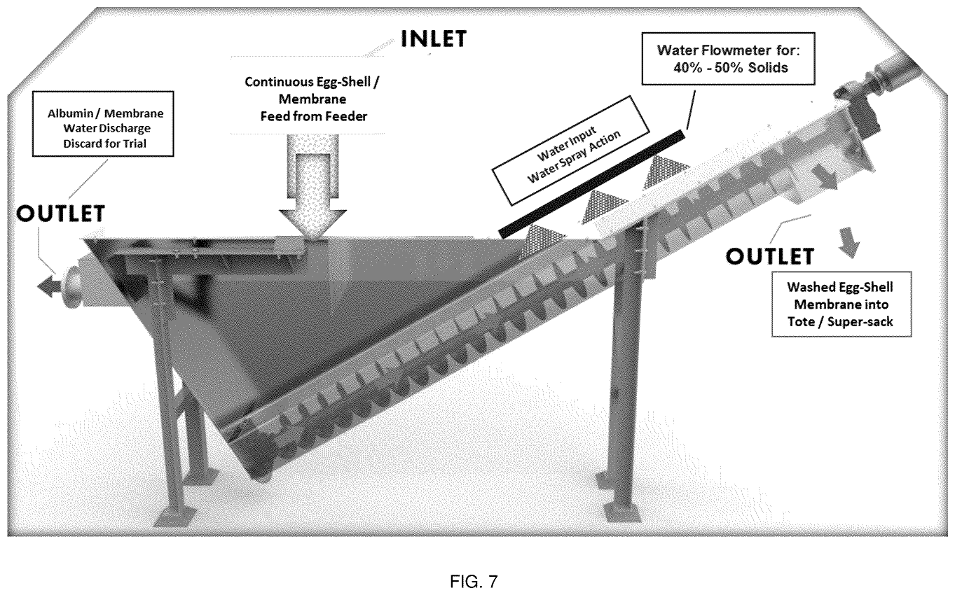

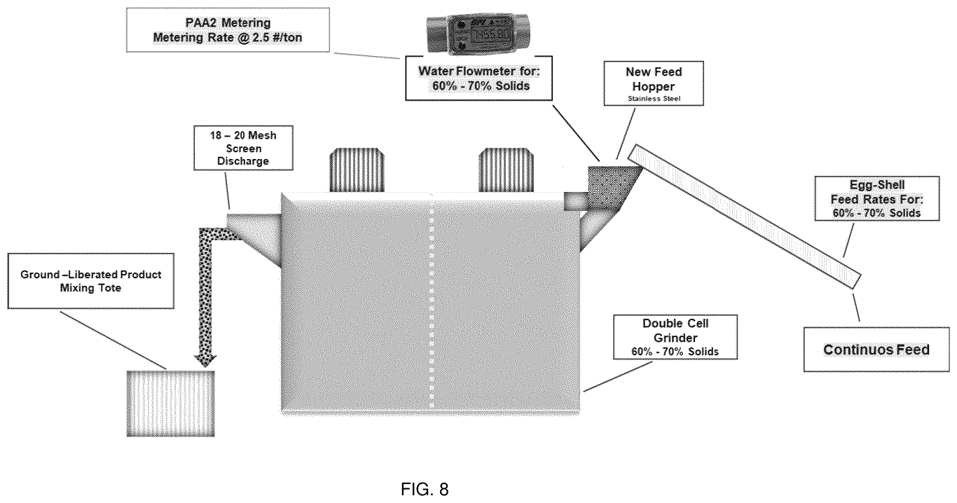

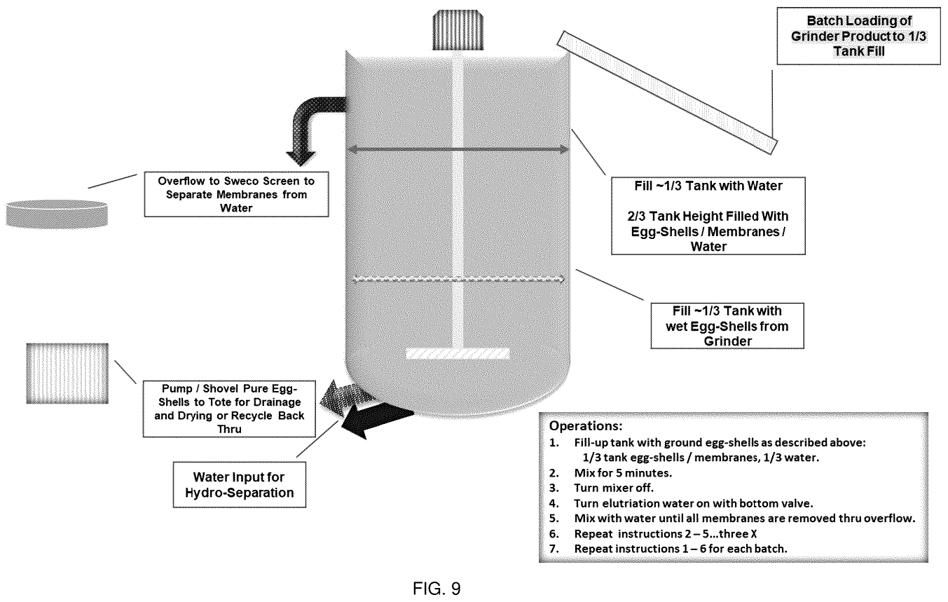

Examples of the methods and equipment for producing large samples at GMT are outlined below with or without order modifications. Step I (Washing Eggshells) utilizes a log washer or sand screw to remove all albumin and begin membrane removal from eggshells. Step II (Autogenous Grinding/Membrane—Shell Liberation (FIGS. 7 & 8)) utilizes a small double cell wet grinder at approximately 60-70% solids. Multiple chemical options are available to aid in sterilization, odor reduction and liberation, such as bleach, sodium hydrosulfite, hydrogen peroxide, biocide, acetic acid, strong acids, acetone, ammonia, ozone, etc.). Step III (Membrane—Shell Separation (FIG. 9)) utilizes a large high-shear blunger as both a hydro-separator and additional liberation/separation with high shear mixing until no visible membrane is released. Membrane can be discarded or collected for further processing and use. Step IV (Membrane—Eggshell Drying) can utilize ovens, or any type/size of calciner/rotary kiln. Low temperature drying at ˜105° C. (ovens, static drying) or higher temperature drying at ˜150°-200° C. (exit temp calciners, dynamic drying) can be utilized.

Examples of the method for dry and hydrous transformational processing for plastics and paint coatings markets is outlined below with or without order modifications. In addition to or in place of steps I-IV, step V (Dry Processing of Demembraned/Sterilized Eggshells) utilizes milling equipment with classification to a d50 of ˜1.8-2.2 μm. Furthermore, application-specific surface treatments can be performed at this step such as many fatty-acid options and siloxane, for example. Step VI (Hydrous/Wet Processing of Demembraned/Sterilized Eggshells) utilizes a combination of ball mills/classification, wet grinders with grinding media, filters, and dryers.

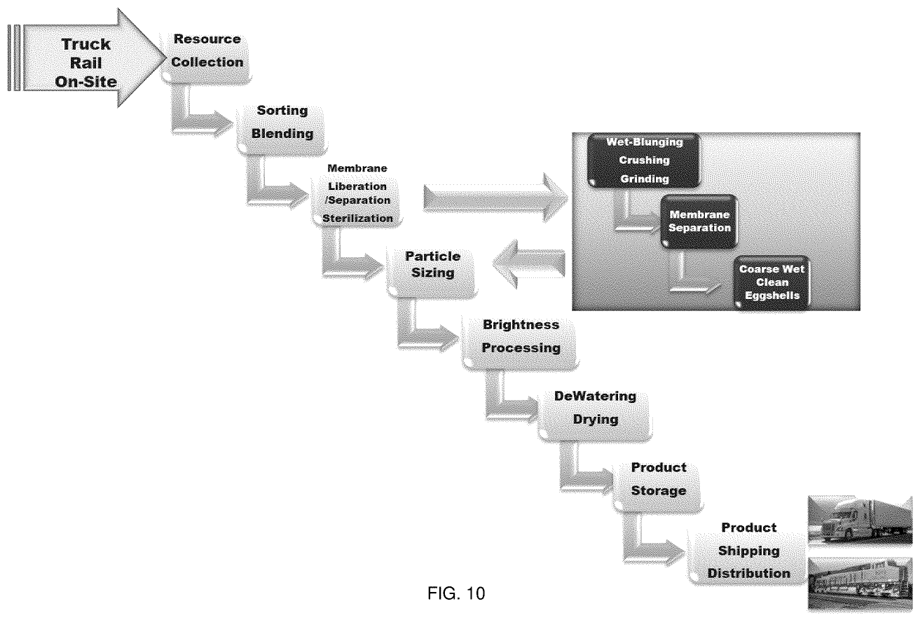

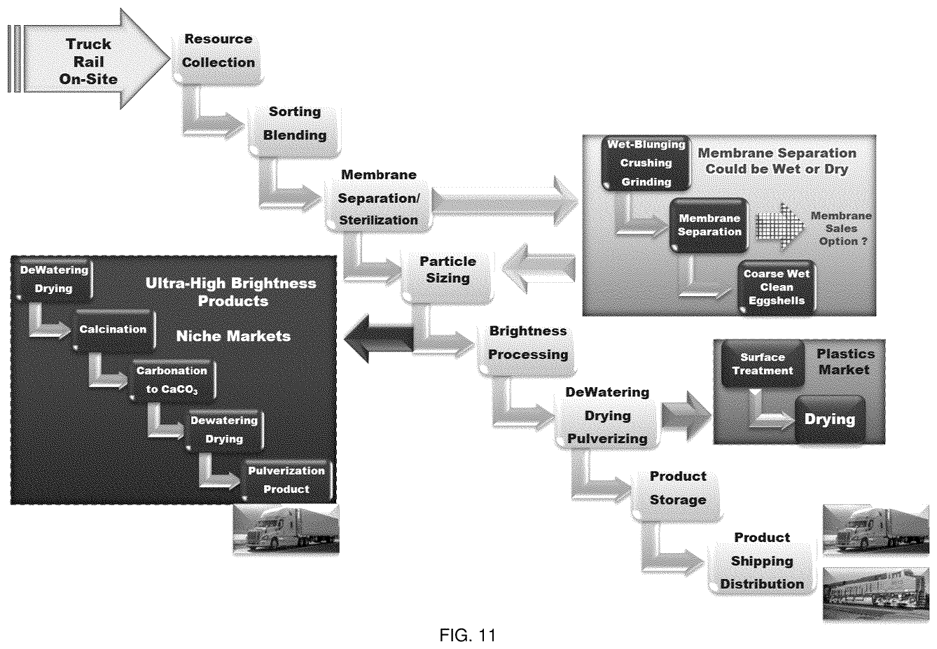

FIGS. 10 & 11 show examples of a basic and fully integrated flowsheet of the outlined transformation from biocarbonate to biomaterial.

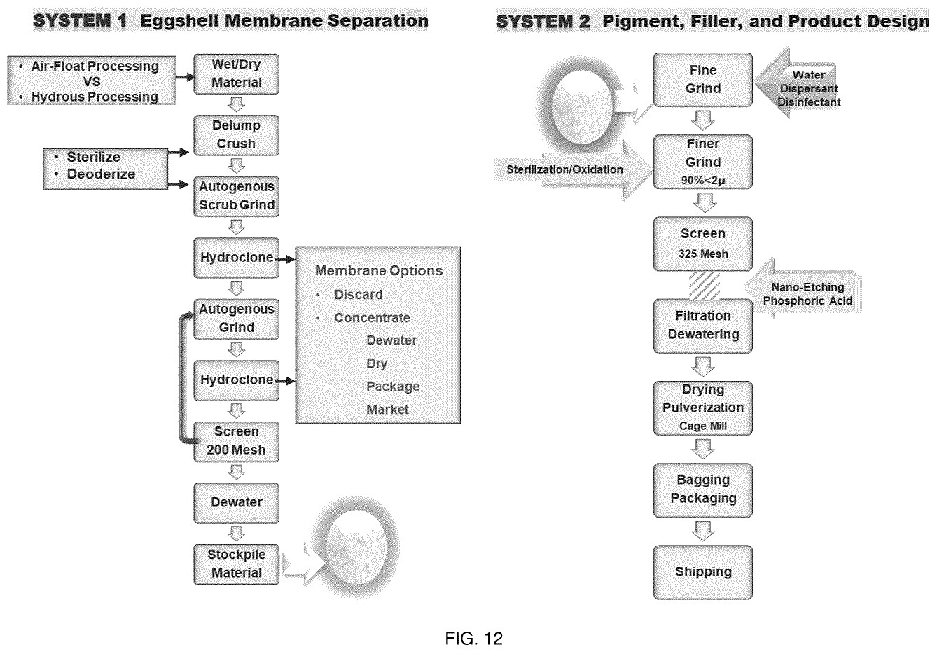

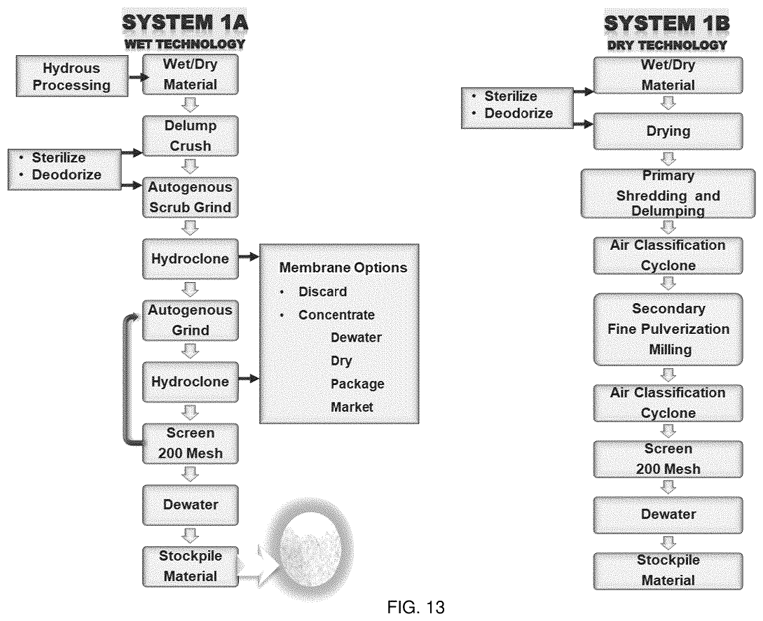

FIGS. 12 & 13 depict examples of the flowsheet of System 1 and 2 in both wet and dry processing options.

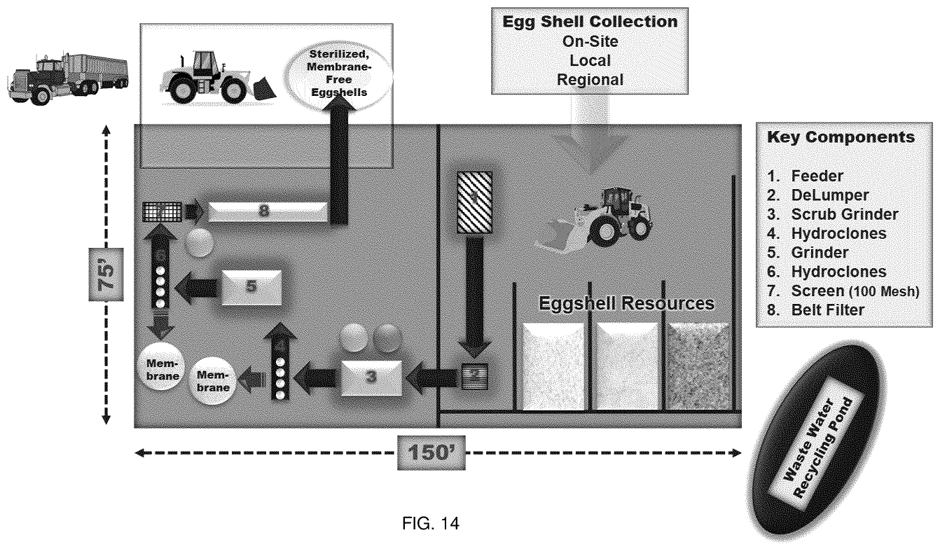

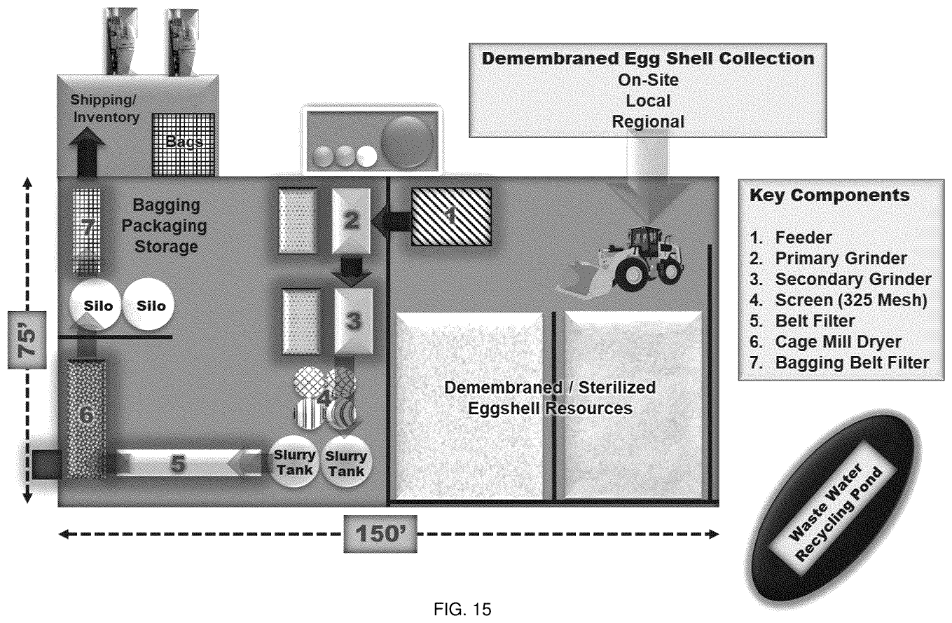

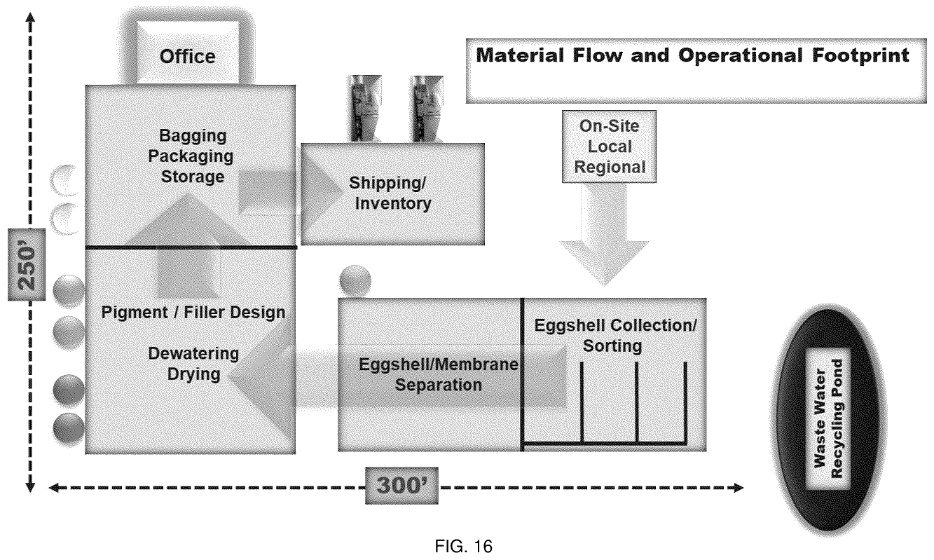

FIG. 14 depicts examples of System 1 on a commercial scale (1-2 tons per hour separation operation and plant design). FIG. 15 depicts System 2 on a commercial scale (1-2 tons per hour pigment and filler operation and plant design). FIG. 16 shows the plan view of the integrated operation design.

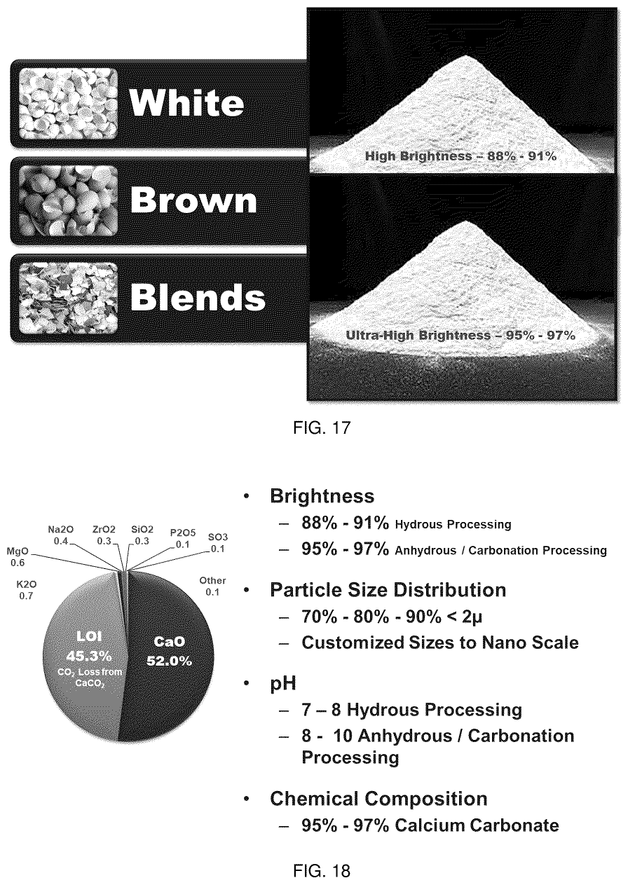

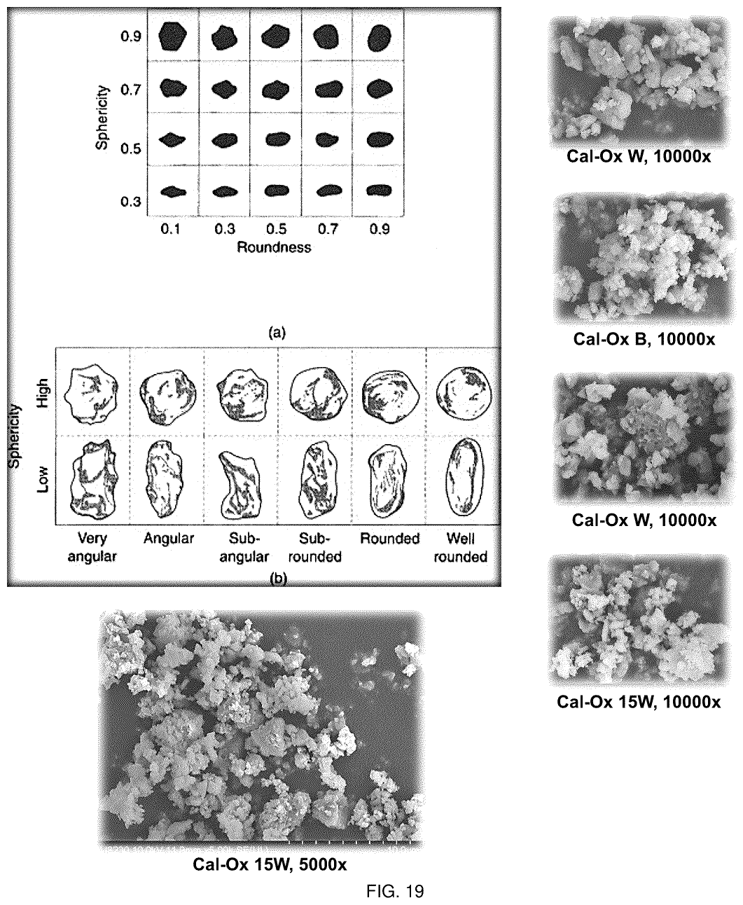

FIGS. 17, 18 and 19 show qualities of the final products made from eggshells.

The business model contingency factors considered are: 1) the types and volumes of eggshell waste, 2) waste location and proximity to processing, 3) BioResource collection sites vs. BioCarbonate end-user locations and 4) flexibility factors and scale-up.

### Product Qualities

The products from this method have very high brightness for BioCarbonates, even when compared with conventional calcium carbonates. The particle size and distributions options with wet-grinding/milling are similar to natural carbonates such as limestone and marble. The Eggshell BioCarbonates have better options for fine and ultra-fine particle sizes such as nano-scale along with better light scattering properties due to morphologies. Calcium Carbonate is the major constituent with limited additional purity processing as compared to natural carbonates. Eggshell products are considered very high purity carbonates.

### Applications and Markets

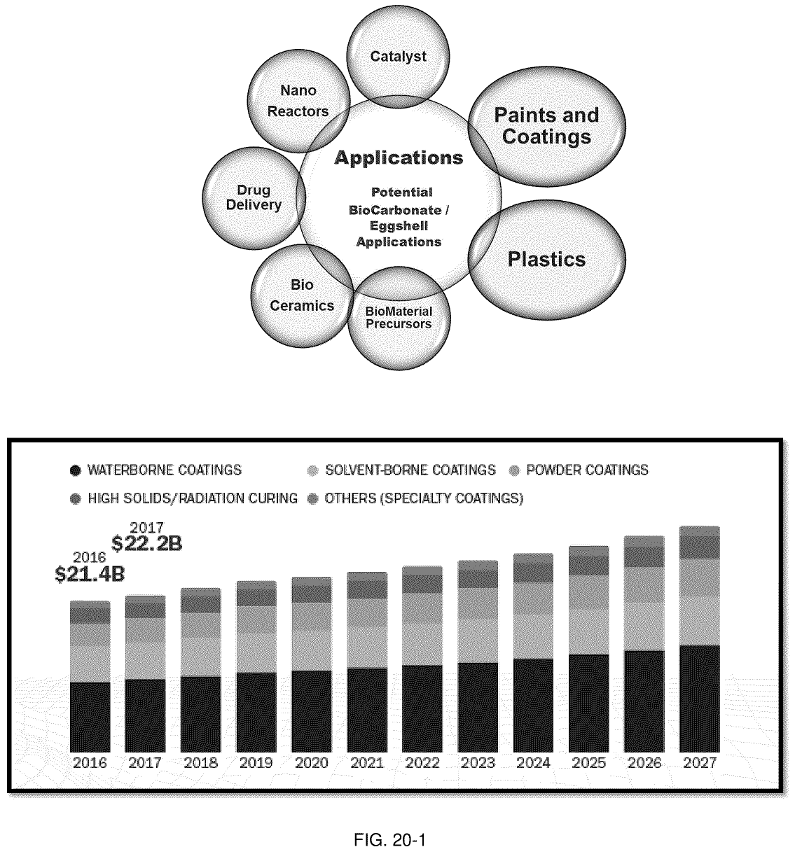

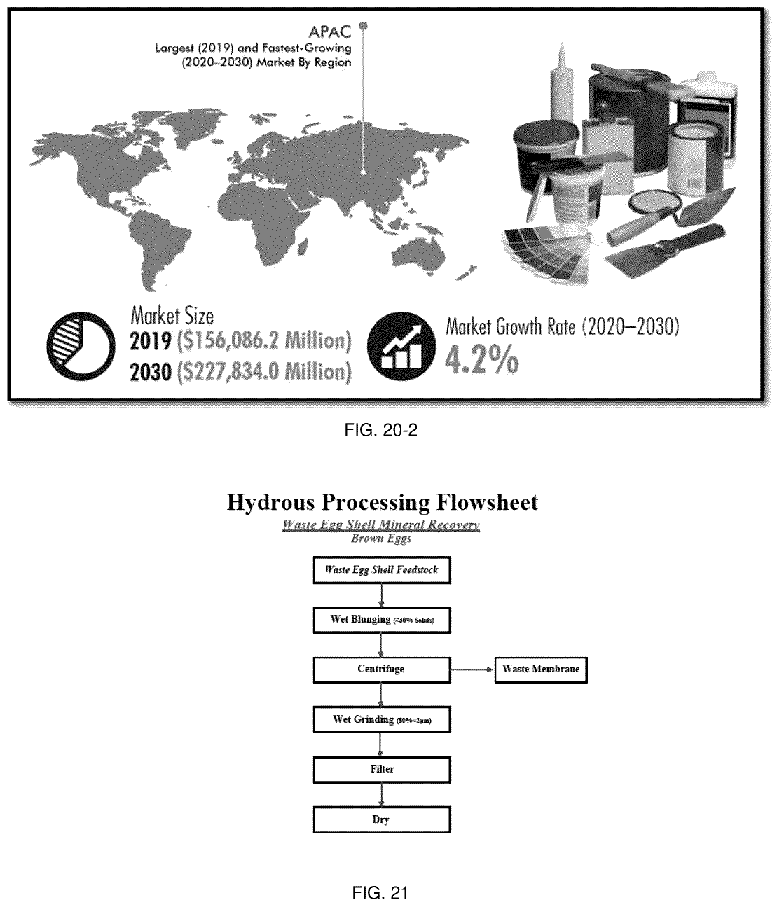

While multiple applications are possible, ECT BioMinerals chose to focus on the Paints/Coatings and Plastics applications markets. A more comprehensive list is shown in FIG. 20. When comparing ECT BioMinerals BioCarbonate against calcium carbonate products, ECT BioMinerals BioCarbonates are substitutes for any calcium carbonate product. The chemical composition, brightness, PSD, and purity are superior to most natural resource carbonates. ECT BioMinerals BioCarbonates are sustainable and do not deplete natural resources. Sustainability is here to stay with a value upside. ECT BioMinerals BioCarbonates eliminates (1) a costly environmental issue, (2) a significant pollution problem, and (3) recovers valuable minerals reducing the traditional mining/processing model system. The BioResources are located in all regions of the world. This reduces the non-value transport and distribution cost.

ECT BioMinerals BioCarbonate™ Products (Paints/Coatings, Paper, and Plastics) consist of hydrous fillers and pigments (BioFil, BioCote, BioFil PCC, BioCote PCC) and anhydrous fillers and pigments (BioTex) as well as functional fillers and pigments.

BioMineral and BioCarbonate Product Applications include any application using calcium carbonates and/or applications that require post-consumer, post-industrial, recycled, etc. materials and resources. These applications include paints, coatings, plastics,

### EXAMPLES

The examples, if presented in the present disclosure, are provided to illustrate embodiments of the present disclosure but are by no means intended to limit its scope. The examples described herein will be understood by one of ordinary skill in the art as exemplary protocols. One of ordinary skill in the art will be able to modify the below procedures appropriately and as necessary.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

### Example 1

### Stage I—Waste Collection, Sorting/Blending for Unique BioResource; Unique Calcium Carbonate Mineral Structure and Purity

This experiment was performed for using white eggshells to produce a possible commercially-viable product.

ECT BioMinerals analyzed seven dozen eggs shells from a local restaurant. All were white in color and had been cracked and removed from their yokes the day of receipt. The following processing techniques were utilized to process the shells: 1) Soaking overnight (approximately 20 hours), 2) Pouring off slime/membrane, 3) Repeated (4-5 times) soaking (1-hour increments) and pouring off slime/membrane, 4) Classification (slime/membrane remained with the finer fraction and the denser shells remained with the coarser fraction), 5) Crushing, 6) Drying, and 7) Pulverization.

The seven dozen eggshells analyzed yielded 400.4 grams or 0.88 pounds. Table 1 below summarizes the results from the shells tested.

TABLE 1

| Sample I.D. | Brightness | L | a | b | pH |
|---|---|---|---|---|---|
| EggShells | 88.50 | 94.97 | 0.08 | 1.91 | 8.85 |

It was determined that white eggshells as a biocarbonate source can be cleaned and pulverized to produce a high brightness product with possible commercial applications.

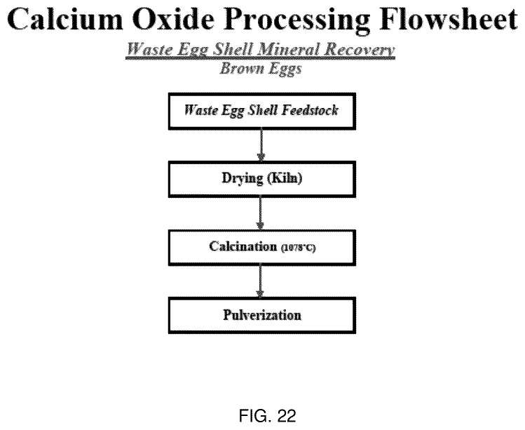

Commercial Source Proof of Concept (Brown Shells): This experiment was performed as the commercial source proof of concept using brown shells. ECT BioMinerals procured nine (fifty-five gallon) drums of eggshell waste taken from a Georgia, USA processing plant. Each drum was filled approximately ½ to ¾ full of brown, semi-crushed eggshell waste. ECT BioMinerals successfully produced three unique products using three independent flowsheets. Each process is illustrated in FIG. 21 and FIG. 22.

It was determined that commercially-obtained brown eggshells can also be cleaned and processed by a variety of methods including wet grinding and thermal processing to produce final products with possible commercial value/applications.

Commercial Source Initial Tests (Mixed Source): Commercial brown and white eggshell waste (mixed) obtained from a Georgia, USA location. All tests through Oct. 2, 2020 used this source.

Purpose: Evaluate effectiveness of washing method and determine what effects ball milling, pulverization and peroxide treatment would have on the final product brightness. The results are shown below in Table 2.

TABLE 2

| Sample | TAPPI | Date | Notes |
|---|---|---|---|
| Batch 1 | 76.45 | May 21, 2020 | Washed, Dried +100° C., pulverized, |
| | | | then ball milled. |
| Batch 1 | 79.21 | Jun. 3, 2020 | Washed. Dried +100° C., then ball |
| | | | milled 5 minutes. |
| Batch 1 | 79.64 | May 21, 2020 | Washed, Blunged with 10#/ton |
| | | | Peroxide, and Dried. |
| Batch 2 | 78.10 | Jun. 2, 2020 | Washed, dried at 120°, then ball |
| | | | milled 5 minutes. |
| Batch 2 | 77.10 | Jun. 3, 2020 | Washed, dried at 120° C., pulverized, |
| | | | then ball milled 5 minutes. |

It was determined that the brown/white shell mixture did not produce brightness values as high as the original all-white shells but could be blended or further processed for brightness optimization.

### Dried Eggshell Trials:

Purpose: since there is no longer able to get source material from the GA location, trials were performed on delumped (uniform particle size), dried (as-is, membrane attached) white eggshells that have been in storage for ˜8 years (hereafter noted as “OES”). Note—even though a stock of brown eggshells is available, the white eggshells were used for the best brightness products that can be testing in the paint applications.

This source was double hammer-milled, wet out and rinsed multiple times to loosen and remove all visible membrane. In addition, 3 mm zirconium grinding media was added in hopes the weight would aid in grinding to the desired particle size range, perhaps more quickly.

The double hammer-milled, demembraned material had a starting brightness of 91.75. Any processing methods that result in a higher brightness are considered beneficiation from the original material.

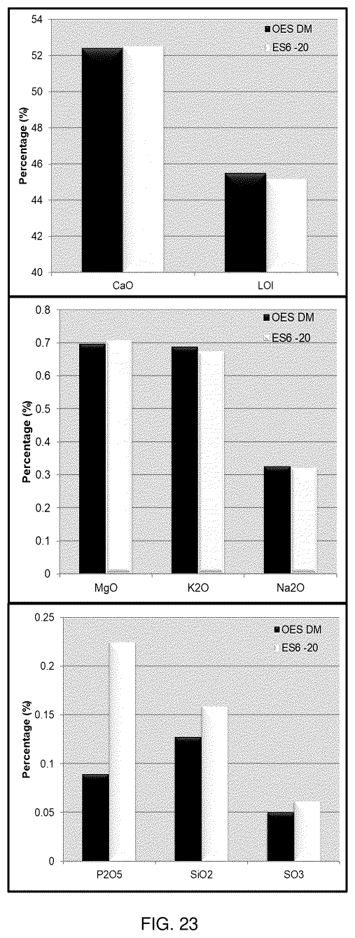

To have a grasp of what differences we might see between the original source material (fresh processed) and the OES, chemistry analysis (XRF) was performed to determine if any major differences existed between the two. As can be seen in FIG. 23, there were no significant differences in content of the major constituents (>0.1%). Some minor differences occurred in the trace components (<0.25%).

It was determined that the source material form (wet/dry) does not affect overall processing and product quality. This experiment also proves consistency of source material across time (years) and location.

### Example 2

### Stage II—Membrane/Eggshell Separation (Dry/Wet/Thermal) & Sterilization/Odor Reduction for Unique Transformation of Eggshell Waste (Mixed & Isolated); and Novel Method of Liberation, Separation & Concentration of High-Quality Pure Calcium

### A More Thorough Membrane Separation Approach (Wet Processing)

Purpose: Evaluate the use of a Cowles mixer float cell to further liberate membranes from shells prior to wet grinding.

As shown in Table 3 below, it was determined that adding high energy/shear significantly helps liberate membranes from shells, are easily removed through flotation/density differences, and positively affect the overall shell brightness.

TABLE 3

| Initial ES Brightness | 1 | 2 | 3 | Average |
|---|---|---|---|---|
| Batch 1: Rinsed | 78.94 | | | |
| Batch 2: Rinsed | 78.04 | | | |
| Double Blunge: Batch 1 | 79.38 | | | |
| Double Blunge: Batch 2 | 79.88 | | | |
| Double Blunge: Mix | 80.05 | 79.53 | 80.07 | 79.88 |

### Air Classification Trial for Membrane Liberation and Removal (Dry Processing)

Purpose: To determine if air classification/winnowing can be an effective method for removing membranes completely unattached to shells based on density.

A simple crosswind setup with a standard fan was used to simulate air classification of membranes from eggshells.

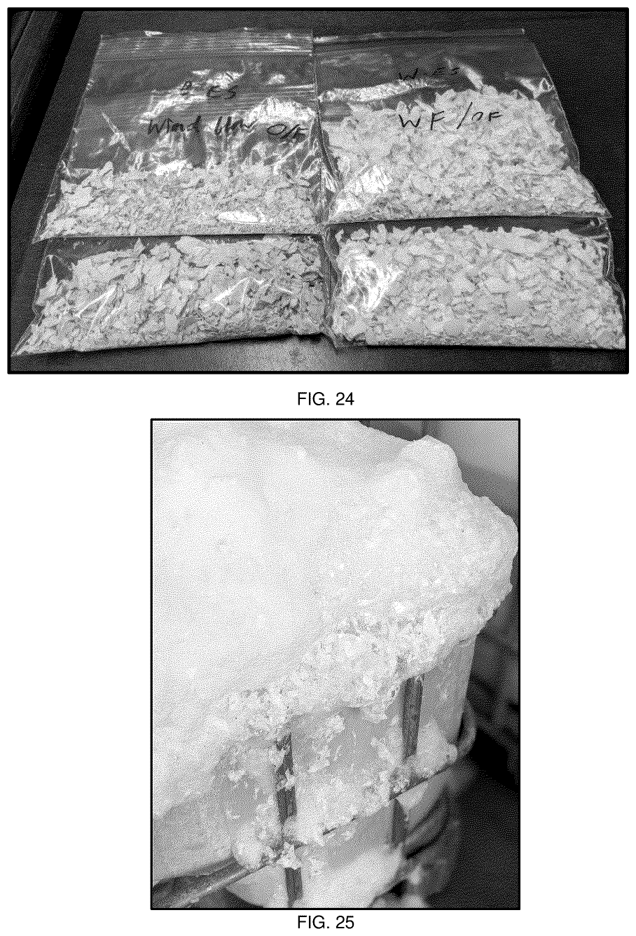

FIG. 24 shows that while membranes still attached to larger/heavier pieces of shell were unable to be classified out, unattached membranes were easily removed by this method.

### Wet Grinding Process Trial (Sterilization/Odor Reduction)

Purpose: to determine optimum wet grind parameters and compare to control brown and white shells brightness results. Produce a fine of a product as possible for paint applications*(target <1 um).

Initial dispersed autogenous grinds were unable to grind most of the material to <325 mesh even after 2 hr., therefore zirconia grinding bead media was necessary.

Recipe:
2:1 weight ratio of 1 mm zirconia beads to shells
70% solids
20 #/ton dispersant

Ground for a total of 3 hours, but only got ˜6.5% solids <325 mesh. Steaming was observed.

$$\begin{matrix}White eggshell control brightness = 91.77 \\ Brown eggshell control brightness = 76.2\end{matrix}$$

Conclusion: While this grind recipe didn't work well, it's likely that the heat generated also effectively steam sterilized the material.

### Peroxide Ladder and Observations for New Source (Sterilization/Odor Reduction)

For the purposes of plastics application, it is preferable for the final product not to contain dispersant. In prior trials, the peroxide treatment was performed post-grind to clean, deodorize, and deactivate the dispersant. For the new source, peroxide treatment was conducted at the beginning, it not only deodorizes/sterilizes at the beginning of the process but may also aid in de-membraning the material.

METHOD: Fresh eggs obtained from a local grocery store were exposed to peroxide levels ranging from 0.2-6.5%, gently mixed for 4 minutes and observed in 2000 mL cylinders to see if visible differences in membrane liberation were seen.

RESULTS: The 1.6% sample had a larger amount of floating membranes than the 0.2 and 0.4% cylinders did. The 2.6 and 6.5% cylinders did not seem significantly better than the 1.6% sample. Membranes still stuck to shells were present in all cylinders. Although it was likely overkill, to ensure complete deoderization and sterilization of the material, it was decided that 1.6% peroxide solution will be used for the new incoming source material.

### Arrival of New Fresh Eggshell Source (Sterilization/Odor Reduction)

As compared to original “fresh” source, this source is much cleaner with no chicken or bitty parts and has a much more pleasant odor, closer to fresh/clean fish. 4½ barrels of screw-pressed wet material arrived. The dosage equivalent is estimated at 250-300 #/ton (estimating ˜250-300 # of dry material/barrel in each half-cut tote).

Five (5) half-cut totes were filled with 80 gallons and water and the contents of an entire barrel.

4 gallons of 32% H2O2 (1.6%/˜250-300 #/ton) were added.

Bubbling ensued immediately upon peroxide addition, and foamy froth began building within the tote, and even overflowed the confines of the tote, carrying with it free, unattached membranes (FIG. 25)

A sample of this froth/membrane combination was collected and dried for later analysis/reference. Total H2O2 treatment was a minimum of 1 hour.

Most of the liquid from the two whole and the half barrel tote was poured off and a quick water rinse was performed. This material was oven dried at 95° C. as-is (visible membrane still included) for potential dry processing (air classification to remove membranes). This dried material was stored in barrels for future experiments.

The remaining two (2) totes were poured off and water-blasted multiple times to remove as much membrane as possible. This process has been used in the past very successfully but did not work as well with this source. To aid in membrane removal, the two totes of material were ground in the large wet grinding pot without grinding media for 10-15 minutes for aid in the separation of the remaining membrane material. Subsequent water washing successfully removed the membrane.

The two (2) totes of cleaned shells were dried at 95° C. for wet grind processing. Current experiments in the works include dry processing to reach the 1.4-1.7 μm range for cost-effectiveness. This process likely includes air classification on a large scale. (Dry Processing).

Thermal processing is also evaluated for membrane removal and purification of calcium carbonate. In addition, GMT also explores creation and application of calcium oxide by this method, which could have different applications. (Thermal Processing)

Hydrogen Peroxide (H₂O₂) Sterilization Optimization

This experiment was performed to determine what level of peroxide is required for sterilization on a commercial scale. Initial use was intentionally overdosed to ensure sterilization and odor control.

Waste resource was obtained from a commercial source and water washed to remove any remaining albumin, etc. but still contained membrane. Shell size was consistent with prior resource pickups obtained from this location. The average moisture of the shells was 21.5%. 100 g of wet shells were added to 250 ml of water and individually treated with 1, 2, 4, 6, 8, 12, and 16 #/ton peroxide while agitated for 1, 2, 4, 16, and 24 hours. A negative control sample (method control) and positive control (untreated shells) were also run and tested simultaneously. At each time/dosage combination, a shell sample was plated on a nutrient agar plate and incubated at 37° C. for 24 hours. All negative and positive controls presented as expected. All test samples showed growth at 24 hours, and decreased amounts of growth as dosage/treatment time increased. However, even at the maximum dosage and time combination, sterility was not achieved. Since higher dosages/longer times are not consistent with commercial scalability, an alternative route for sterilization/odor control will be tested.

Biocide and Hydrogen Peroxide-Biocide Combination Sterilization Trials

This experiment was performed to determine if biocide alone or a combination of peroxide and biocide could achieve sterilization on a commercial scale.

Biocide (BCS3096W) was tested at the recommended dosage of 1.4 #/ton. For the combination, this biocide dosage plus the highest cost-effective dose of H₂O₂ (8 #/ton) will be tested at 1-, 8-, and 24-hour treatments times and plated with negative+positive controls to see if sterilization/odor control can be accomplished.

Results: All control results were as expected. All options tested showed none/almost no growth at 24 hrs. incubation. The combination showed less growth than the biocide only counterpart, so there could be a benefit of the combination over the biocide alone, with regard to the time required for sterilization. Both the biocide and combination at 24 hours showed very little growth/no growth and both could be viable options for sterilization with further study. However, 24-hour treatment times are not economically viable on a commercial scale, so additional trials will be performed to find a sterilization method that requires much less time.

### Initial Peracetic Acid (PAA) Trials

This experiment sought to determine the effectiveness of PAA for sterilization and begin to determine required dosage level. Resource used was 20 days aged from pickup and had been kept refrigerated. With similar format to prior runs, the PAA dose range tested was 1.3-1.8 #/ton with both negative and positive controls for 5-, 10-, and 15-minute treatment time. Nutrient agar plates evaluated after 24 hours incubation at 37° C. All treatment times of dosages 1.3, 1.4, and 1.5 #/ton showed growth after 24 hours. However, dosages 1.6-1.8 #/ton showed no growth/very little growth after 24 hours, proving PAA to be a viable option for commercial scale. The effects of the sterilization method on brightness are recorded under Stage 3.

### Wastewater Treatment/Protein Recovery Trials

This experiment sought to determine if solubilized/remaining albumin/protein could be recovered from the wastewater, not only providing a process co-product, but also recycling process water. Post-process water trials with and without sterilization treatment were heated to boiling at neutral to basic pH to observe effects on both visual recovery and resulting liquid. A control sample spiked with recovered membrane served as a visual control. The addition of heat caused the protein content to solidify, leaving the water visibly clearer. The additions of high pH and sterilization treatment aided in this effect occurring at a lower temperature.

### Initial Odor Trials

Initial plastic applications tests reported a slight “sulfur-like” smell during processing. ECT BioMinerals sought to determine the origin of the odor and how to remove it for application purposes.

The plastics industry processes employ higher temperatures than ECT BioMinerals used to produce its biocarbonate. This experiment sought to determine if the odor could simply be volatilized off by exposing the biocarbonate to higher temperatures in the plastics applications range before it was tested. All observations were made using olfactory capabilities only.

Cleaned, demembraned, untreated shells were heated to the following temperatures: 105 (typical drying temp), 180, 210, and 240° C. (plastic application temp range) for extended time periods and monitored regularly for odor and appearance.

Results: Any remaining membrane seemed to “burn off” at higher temperatures. The discoloration seen was most likely due to the extended time at the given temperatures. Odors at ˜2.5 hours (at temperature) were described as “eggy” for 105° C. and “earthy” for the upper temperatures. A final cooled test of the upper temperatures detected no smell, but the 105° C. retained a slight “eggy” smell. The odor may be linked to any remaining membrane content. A thermal profile between 105° C. and 180° C. is pursued.

### Membrane Odor Trials

To determine if/how much membrane and/or PAA plays a role in odor, untreated and PAA-treated shells and their associated collected membranes are heated to the temperature range of 105-180° C. to observe odor and appearance. Due to heating capabilities, the higher temperatures utilize muffle furnaces which the lower temperatures use a forced-air oven.

RESULTS: The higher temperatures (160 and 180° C.) ran in the muffle furnaces retained more odor, presumably because of its status environment that is not vented, which would allow released odor to be removed. This environment also encouraged shell discoloration more quickly. The oven-heated 125 and 145° C. samples did not show visual discoloration and had no observable odor once heated or after cooling. It may be possible to increase the drying temp (if that is determine to help remove odor) without negatively affecting brightness.

### PAA Odor Trials

Since membrane does not seem to be contributing to odor, PAA could be contributing. This experiment sought to determine if PAA dosage can be lowered and supplemented with H₂O₂, still achieve sterility and reduce/eliminate odor.

Since 5 min of PAA treatment has been shown effective, this experiment tested 30 seconds—4 minutes treatment time of 1-week aged, refrigerated shells with PAA concentrations ranging from 1.0-1.6 #/ton and total H₂O₂ ranging from 2.6-16.0 #/ton. Free H₂O₂ content in the PAA was accounted for and supplemented as needed. Samples were plated using sterile technique onto nutrient agar plates, incubated at 37° C. for 24 hours and observed for growth.

RESULTS: As was noted in previous experiments, foam levels were confirmed to increase with H₂O₂ addition. The negative control showed no growth. However, all other tests showed growth, even dosages that previously proved effective (1.6 #/ton) at similar treatment times. This experiment is repeated with freshly obtained resource and freshly diluted PAA.

RETEST RESULTS: While the overall amount of growth on the plates was much less, the retest results were the same, showing growth on all test plates with a no growth negative control.

These results show that biological load likely increases with storage time (even refrigerated) and that biological load likely varies from source, both of which encourage an immediate processing plan for commercial scale. Fresh resource is used in further tests (used within 24 hours of receipt).

### Initial Heat Only Sterilization Trial

Since PAA may still be contributing to odor, ECT BioMinerals sought to explore the option of sterilization/odor elimination through heat only. It also sought to determine if PAA was linked to the previously seen discoloration. Since heat does eventually cause discoloration, sterility, odor and brightness were monitored for this experiment.

A sample of non-PAA-treated and PAA treated (1.7 and 1.8 #/ton for 30 sec, 1, 2, 4, 5, and 6 minutes) were dried at 145° C. in 1 hr. increments until moisture was <0.5%. At each step, sterility, odor and brightness were monitored for comparison.

RESULTS: All controls presented as expected. Growth at 24 hrs. was seen on all plates, although the level was lower than previously seen. This included 1.8 #/ton PAA, which had been previously shown effective, further supporting that biological load varies from the source, even when used immediately. The heat-only sample showed a small amount of growth, but PAA+heat showed no growth, even far after the 24 hours incubation period. No samples showed concerning visual discoloration.

### Heat Only Sterilization Trial—2

Further trials to evaluate heat-only sterilization at 160 and 180° C. for 1 hr. were conducted to see the ability of sterilization and its effects on odor and brightness.

RESULTS: The results are shown in Table 4 below:

TABLE 4

| | Moisture | | | |
|---|---|---|---|---|
| | (%) after | | | |
| | 1 hr | | Bright- | |
| Sample | drying | Sterility | ness | Odor Observation |
| 160° C. | 2.35 | Minor | 91.66 | Slight “eggy” smell after |
| | | | | heating and cooling, more than |
| | | | | 180 C. sample. Ball-milled |
| | | | | sample has earthy odor. |
| 180° C. | 0.37 | None | 93.99 | Slight “eggy” smell after |
| | | | | heating and cooling, less than |
| | | | | 180 C. sample. Ball-milled |
| | | | | sample has same earthy odor. |

RESULTS: The 160° C. sample downs minor growth at 24 hours, while the 180° C. sample remained free of growth even after 50 hours.

### Initial Temperature Profile for Heat Sterilization

This experiment sought to evaluate heat-only sterilization as a viable option.

Fresh shells were washed and demembraned via autogenous grinding. They were then pre-dried at 105° C. for ˜3 hr. until moisture levels were <0.5%. Shells were dried at the following temperatures in a forced-air oven for 10 min—1 hour (10 min increments) with consistent bed thicknesses and monitored for sterility and brightness: 150, 160, 170, 180, 190, 200, 225° C.

RESULTS: While positive controls resulted as expected, it was found that some of the pre-dried samples showed no growth, suggesting that sterilization was reached during the pre-drying step before any of the trialed temperatures. All tested samples were negative, but discoloration was a factor for the upper temperature/time combinations. The experiment was repeated without pre-drying, adding agitation to more closely mimic the dynamic environment of a rotary dryer, and used a worst-case scenario resource.

### Temperature Profile for Heat Sterilization—2

Approximately 4 weeks aged unrefrigerated resource was used to repeat the initial temperature profile without pre-drying and adding regular agitation during drying. Temperature range remained at 160-225° C., times tested were 20, 40 and 60 minutes for sterility, brightness, and odor observations.

RESULTS: Odors prior and after heat treatment were particularly putrid, most likely given the age and storage conditions of the resource. The positive control plate grew as expected, however, all test plates remained clear until minor growth started at the 1-week mark, but only on the 20-minute samples. For calciner drying trials planned, ECT BioMinerals targets >20-minute retention time for sterility and between 150° C.-180° C. for maintenance of brightness >90 (Data shown in Stage III).

### Large Sample Trial of Heat-Only Sterilization

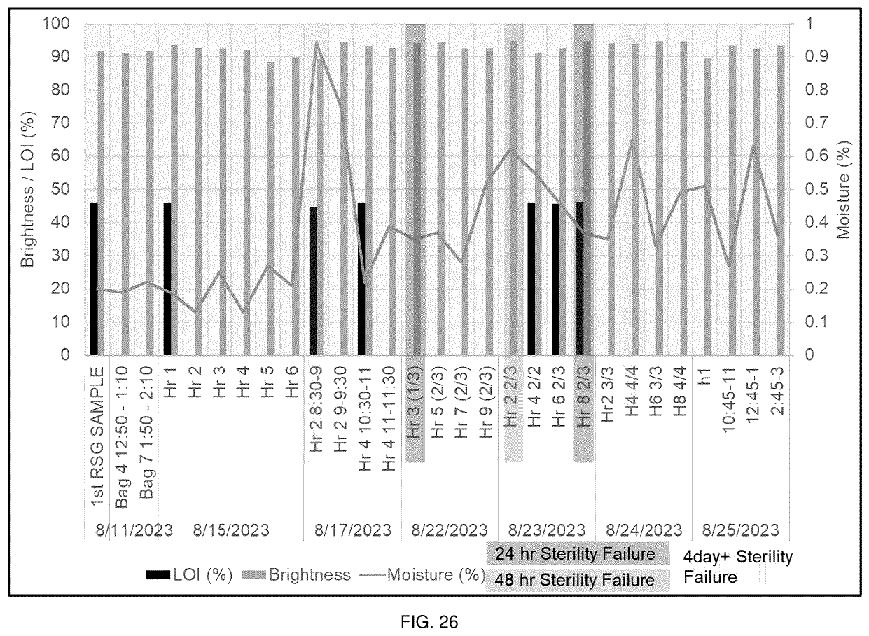

ECT BioMinerals' small rotary calciner was used to produce several hundred pounds of product for subsequent dry grinding. Brightness, sterility and moisture were monitored throughout the run. FIG. 26 shows the KPIs monitored throughout the run along with sterility results. Sterility failures were seen when moisture was >˜0.5% and/or the bed temperature was <˜120° C.

### Odor Trials—Test 1

This experiment sought to pinpoint the culprit of the “faint sulfur-like” odor the customer noticed during plastic application testing, which was determined to hit 218° C. Several samples from the Large calciner trial were chosen alongside the sample that was found to emit the odor as a control. Samples were sealed, heated to 218° C. and observed for odor. No sulfur-like odors were found, but the original odoriferous sample had an earthy odor, while all calciner samples emitted a slight ammonia-like odor that quickly dissipated.

RESULTS: Since plastic application testing occurs once the product is ground to a fine particle size, samples that have been ball-milled prior to 218° C. heating were re-examined.

### Odor Trials—Test 2

Test 1 was repeated with material that was ballmilled to reduce the particle size. While the originally tested sample didn't emit any detectable sulfur smell, all other test samples had the same, quickly-gone, ammonia-like smell. Tests were confirmed with another observer and samples that were exposed to higher calciner temps were included.

Odor Analysis was completed for one calciner sample (Table 5) and the original sample with odor (Table 6) to determine a baseline analysis and how odors may be changing. Those results are shown below.

TABLE 5

| | Estimated | |
|---|---|---|
| Volatile Odor Compounds | Concentration | Associated |
| Found | (ppm) | Odor |
| Acetone | 6.57 | Sharp, nail polish remover |
| 2-Butanone | 0.51 | Similar to acetone |
| Dimethyl Disulfide | 1.04 | Garlic-like |

TABLE 6

| | Estimated | |
|---|---|---|
| Volatile Odor Compounds | Concentration | Associated |
| Found | (ppm) | Odor |
| Acetone | 2.20 | Sharp, nail polish remover |
| 2-Butanone | 0.25 | Similar to acetone |
| Dimethyl Disulfide | 1.40 | Garlic-like |

### Odor Trials—Test 3

Test 2 repeated with samples (not ballmilled) that range from non-sterile to a temperature of 150° C. With three total observers, all samples exhibited an odor being described from ammonia-like to chemical-like, some having a sweet almost yeasty smell. RESULTS: Ultimately no samples were odor free, but none exhibited a sulfur-like smell.

### Odor Trials—Test 4

To test if ballmilling doesn't get the material particle sized down enough, this test pulverized the sample prior to heating and odor observation.

RESULTS: Although levels and types of odor had some variation, there were no samples that were odorless.

### Odor Trials—Test 5/6

This experiment sought to determine if increasing surface area through hammermilling before exposing to drying temperatures causes the release of whatever the odor is. Sterility was also monitored to determine if hammermilling was releasing anything unsterile that might also be producing odor. The (2) samples chosen had seen 1) higher drying temperature, previously testing negative for growth and 2) seen lower drying temperatures, previously testing positive for growth. This setup would help determine if bacterial growth could be linked to the odor in question. After hammermilling, the samples were exposed to: 160° C., 190° C. and 200° C. for 20 and 40 minutes each. Samples were re-evaluated for sterility and a 218° C. odor test was performed. Particle size analysis via RoTap was also performed to determine what changes hammermilling had made to the particle size.

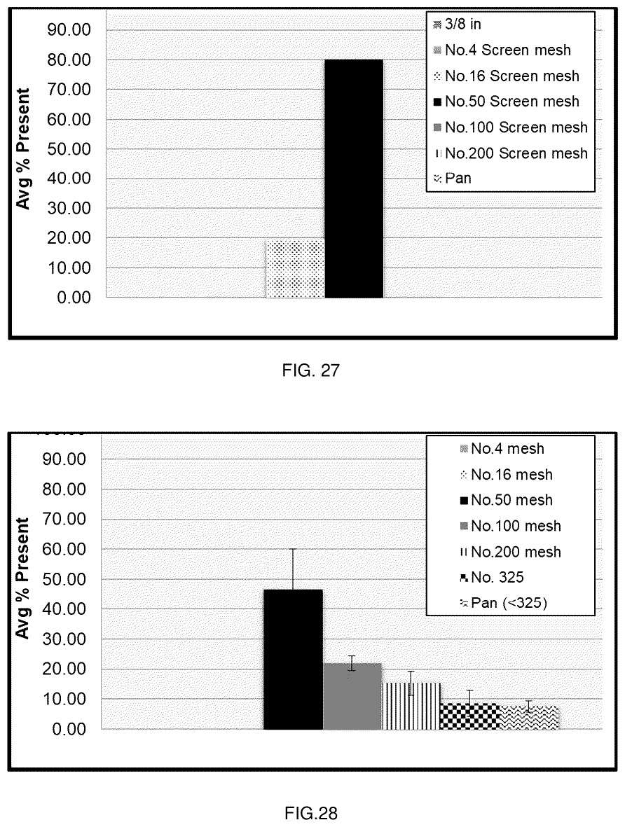

RESULTS: While no growth was seen on the pulverized samples at 24 hours, growth was seen after an extended period of 11 days. The particle size data comparison is shown in FIGS. 27 and 28. The hammermilling process removed the 16-mesh fraction, lowered the 50 mesh fraction and created a <50 mesh fraction comprising ˜50% of the material, ˜7% of which was <325 mesh. There were no odorless samples.

### Odor Trials—Test 7

Although membrane had been tested before, it had never been tested ballmilled, so this experiment determines if the odor is caused by the membrane once it's reduced in particle size. In addition to the retained samples from the Membrane Odor Trial (CM and PM at 125° C. and 180° C. each), peroxide-treated membrane mixed shells retain and ground virgin material treated at 15% solids with 4.4 #/ton peroxide were ballmilled and tested for odor at 218° C.

RESULTS: All samples exhibited a “burnt popcorn” type smell both after ball milling and after cooling except the peroxide treated membrane, which lost that signature odor once cooled. Odor detected nothing like sample odor detected in previous tests.

### Odor Trials—Test 8

This experiment was performed on the thought that perhaps pulverization/hammermilling was not allowing the particle to reach the target size for plastic application (˜2 μm), which was the size that originally exhibited the odor. Since it was unable to reach this d50 size in a dry process, the following samples were tested: 1) the coated original odiferous sample, with coating stripped via isopropyl alcohol, and water washed with vacuum filtration, 2) wet-ground untreated GMT-Rcarbonate with a d50˜0.5 μm, and 3) 1.7 #/ton PAA-treated versions of both 1 and 2 above.

All samples were exposed to 150° C., 175° C., and 200° C. for 30 minutes. Then the samples underwent the now standard foil-covered 218° C. in-house odor evaluation. All final odor tests resulted in varying levels of the signature “earthy” type smell as in all prior tests. No samples were deemed desirable for analytical odor analysis.

### Wet-Ground PAA Treatment—Odor

PAA treatment may be more effective (Sterilization and odor) at a finer particle size. Therefore, another set of PAA experiments seeks to discover the sterilization and odor effects of a wider range of PAA doses.

The wet-ground (not dispersed) material had an average d50 of ˜1.4 μm. The PAA dose range tested was 1.0, 1.5, 1.8, 2.5 and 3.0 #/ton.

Upon treatment and oven drying, a vinegar type odor was detected that grew stronger as the PAA concentration increased, most likely due to the free acetic acid in PAA (aka vinegar). This may be due to the PAA not being sufficiently rinsed prior to drying. pH analysis of the samples before and after water washing showed an increase in pH after washing, which suggests that residual PAA was in the sample.

Further analysis on these samples was performed to evaluate if gravity separating the treated sample would remove the odor in the liquid portion. Also, combinations of water washing and post heating were performed at 160 C and 180 C for the 1.5, 2.5, and 3 #/ton treatment levels. 218° C. heated odor tests were then performed. Based on the results observations, the highest PAA-treated/water-washed sample with and without post-heating were sent for odor analysis.

The results table for the following samples is shown below. WG-2.5 Sample 1A (wet-ground, 2.5 #/ton PAA, water washed) is shown in Table 7. WG-3.0 Sample 2B (wet-ground, 3.0 #/ton PAA, water washed) is shown in Table 8. WG-2.5H Sample 3C (wet-ground, 2.5 #/ton PAA, water washed, heated to 150° C. for 15 min) is shown in Table 9. WG-3.0H Sample 4D (wet-ground, 3.0 #/ton PAA, water washed, heated to 180° C. for 12 min) is shown in Table 10.

TABLE 7

| Volatile Odor Compounds | Estimated Concentration | Associated |
|---|---|---|
| Found | (ppm) | Odor |
| Isopropyl Alcohol | 569 | Sharp, Alcoholic |
| 2-Ethyl-1-Hexanol | 24.6 | Floral |

TABLE 8

| Volatile Odor Compounds | Estimated Concentration | Associated |
|---|---|---|
| Found | (ppm) | Odor |
| Isopropyl Alcohol | 561 | Sharp, Alcoholic |
| 2-Ethyl-1-Hexanol | 12.6 | Floral |

TABLE 9

| Volatile Odor Compounds | Estimated Concentration | Associated |
|---|---|---|
| Found | (ppm) | Odor |
| Isopropyl Alcohol | 46.9 | Sharp, Alcoholic |
| 2-Ethyl-1-Hexanol | 9.60 | Floral |

TABLE 10

| Volatile Odor | Estimated Concentration | Associated |
|---|---|---|
| Compounds Found | (ppm) | Odor |
| Isopropyl Alcohol | 187 | Sharp, Alcoholic |
| 3-Heptanone | 0.75 | Sweet, Fruity |
| 2-Ethyl-1-Hexanol | 10.9 | Floral |

Since no sulfur-containing odors were found, a bulk run of the wet-ground, 2.5 #/ton PAA-treated biocarbonate material was produced. Only the floral odor was detected as shown below in Table 11.

TABLE 11

| Volatile Odor | Estimated Concentration | Associated |
|---|---|---|
| Compounds Found | (ppm) | Odor |
| 2-Ethyl-1-Hexanol | 5.72 | Floral |

RESULTS: The wet-ground particle size was instrumental in achieving both sterilization and odor elimination. However, it was noticed that no PAA dosage above 1.8 #/ton had been used on the cleaned, demembraned shell size. To confirm that the dosage was not the reason for the achieved success, the heat-only processed samples were tested at 2.5 and 3.5 #/ton PAA. The results are provided below in Table 12 and 13, respectively, with only isopropyl alcohol as a result (could be tied to ballmill cleaning). However, no sulfur-containing odors were detected, therefore for large-scale production reasons, a bulk sample is produced using the previously calciner-dried material with the newfound successful PAA treatment dosage.

TABLE 12

| Volatile Odor | Estimated Concentration | Associated |
|---|---|---|
| Compounds Found | (ppm) | Odor |
| Isopropyl Alcohol | 5.53 | Sharp, Alcoholic |

TABLE 13

| Volatile Odor | Estimated Concentration | Associated |
|---|---|---|
| Compounds Found | (ppm) | Odor |
| Isopropyl Alcohol | 136 | Sharp, Alcoholic |

### Large Run—Odor Test

All remaining material that was previously calciner-dried was PAA-treated at 2.5 #/ton, water washed and dried. Odor results are listed below in Table 14 and were completely negative for any GCMS-detectable odor.

TABLE 14

| Volatile Odor | Estimated Concentration | Associated |
|---|---|---|
| Compounds Found | (ppm) | Odor |
| None | NA | NA |

### Example 3

### Stage III—(Particle Sizing, Enhanced Brightness Processing, Thermal Processing/Carbonation/Filtration/Drying) for Unique Transformation of Eggshell Waste (Mixed & Isolated); and Novel Method of Liberation, Separation & Concentration of High-Quality Pure Calcium

Process Treatments for Optimizing Brightness: This Experiment was Performed to Determine which Brightening Agents are Worth Further Pursuit.

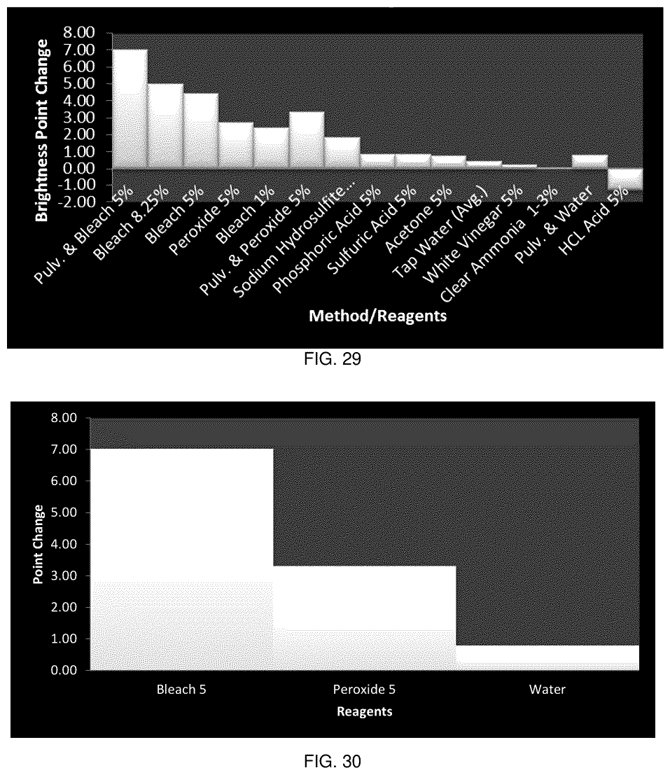

All blunging recipes were 50% solids in a Waring blender for 3 minutes at speed 80. All blunged samples were immediately vacuum filtered on #1 Whatman filter paper till dry and then further dried in the ovens at 120° C. for at least 1 hour. The raw data in Table 15 below corresponds to FIG. 29.

TABLE 15
Raw Data

| | | | Point | | |
|---|---|---|---|---|---|
| Method & Reagent | Conc. % | Brightness | Change | #/Ton | |
| Pulv. & Bleach 5% | 5.00 | 84.12 | 7.02 | 111 | |
| Bleach 8.25% | 8.25 | 83.07 | 4.97 | 183.15 | |
| Bleach 5% | 5.00 | 82.50 | 4.40 | 111 | |
| Peroxide 5% | 5.00 | 80.81 | 2.71 | 145 | |
| Bleach 1% | 1.00 | 80.52 | 2.42 | 22.2 | |
| Pulv. & Peroxide 5% | 5.00 | 80.41 | 3.31 | 145 | |
| Sodium | 5.00 | 79.95 | 1.85 | 250 | |
| Hydrosulfite 5% | | | | | |
| Phosphoric Acid 5% | 5.00 | 78.94 | 0.84 | 188 | |
| Sulfuric Acid 5% | 5.00 | 78.94 | 0.84 | 184 | |
| Acetone 5% | 5.00 | 78.85 | 0.75 | 79 | |
| Tap Water (Avg.) | 100.00 | 78.51 | 0.41 | 2000 | |
| White Vinegar 5% | 5.00 | 78.33 | 0.23 | 101 | |
| Clear Ammonia 1-3% | 1-3% | 78.16 | 0.06 | 20 | 59 |
| Pulv. & Water | 100.00 | 77.89 | 0.79 | 2000 | |
| HCL Acid 5% | 5.00 | 76.82 | −1.28 | 81 | 123 |

*Point Change Comparisons related to pre-blunged brightness:
Pre-blunged Non pulverized brightness: 78.10
Pre-blunged Pulverized brightness: 77.10

The following conclusions were drawn: 1) Highest point change observed from pulverization and blunging with bleach. 2) Peroxide was the next best whitening agent being just under 50% as effective as bleach. 3) Only peroxide blunging and bleach blunging achieved brightness's above 80.00. 4) Pulverization initially lowers brightness by a point (Most likely due to wearing effect on the blades) but improves the whitening effects of reagents by up to ˜190% in the case of a water blunge, ˜160% in a bleach blunge, and ˜120% in a Peroxide blunge. 5) Cannot use bleach and peroxide together due to chlorine gas production. 6) Bleach and peroxide are primary reagents of interest. Effects of Product Pulverization/Increase of Surface Area: The purpose of this experiment was to determine if treating pulverized material yields a brighter product that treating unpulverized material due to surface area.

These results are shown in Table 16 and FIG. 30. It was determined that pre-pulverized material does produce higher brightness products. Therefore, a higher surface area aids in processing treatment for brightness.

TABLE 16

| | | | | Non Pulv. | |
|---|---|---|---|---|---|
| | | | Point | Point | % |
| Reagents | Conc. | Brightness | Change | Change | Increase |
| Bleach 5 | 5% | 84.12 | 7.02 | 4.4 | 160 |
| Peroxide 5 | 5% | 80.41 | 3.31 | 2.71 | 122 |
| Water | 100.00% | 77.89 | 0.79 | 0.41 | 193 |
| Egg Shells 3 | N/A | 77.10 | N/A | | |

*Washed, Dried, Pulerized, and Ball milled 5 min.

Wet Grind Trials continued—Purpose—Using recipe below, evaluate grinding effectiveness and post-grind processing options (classification, centrifugation, peroxide, bleach (2-16 #/ton), leach (1-16 #/ton) and phosphoric acid treatments for maximum brightness result.

RECIPE:
50% solids solution of <50 mesh hammer-milled eggshells
1.4:1 1 mm zirconia beads to eggshell solutions
5 #/ton dispersant (4306)
1 hour grind

Due to foaming/spillage, volume adjustments need to be made for future tests. It is likely that the addition of acid to a calcium carbonate in water (=CaOH) is producing calcium sulfate and water and fizzing is likely a reaction between CaCO₃ and the acid, giving off CO2. Higher dispersant dosage may negatively affect brightness, try 2 #/ton next trial.

### Leach Observations:

Following the kaolin industry standard of attempting to lower the pH of a solution to <3 prior to leaching, the following observations were made. Calcium carbonate does not typically produce flocs in water. The flocculation process (precursor requirement to leaching) showed that sulfuric acid caused foaming and would not reduce pH past ˜6.

### Phosphoric Acid Observations:

When phosphoric acid was added, a pH of <5 was obtained, but returned to ˜6 after 1 hour and foaming. Defoaming agents yielded no positive effect. Resulting filter cakes had a porous appearance.

### Centrifugation:

The underflow (primarily ground shell material) gained 3 brightness points over the starting material (as expected). The overflow lost ˜2 brightness points.

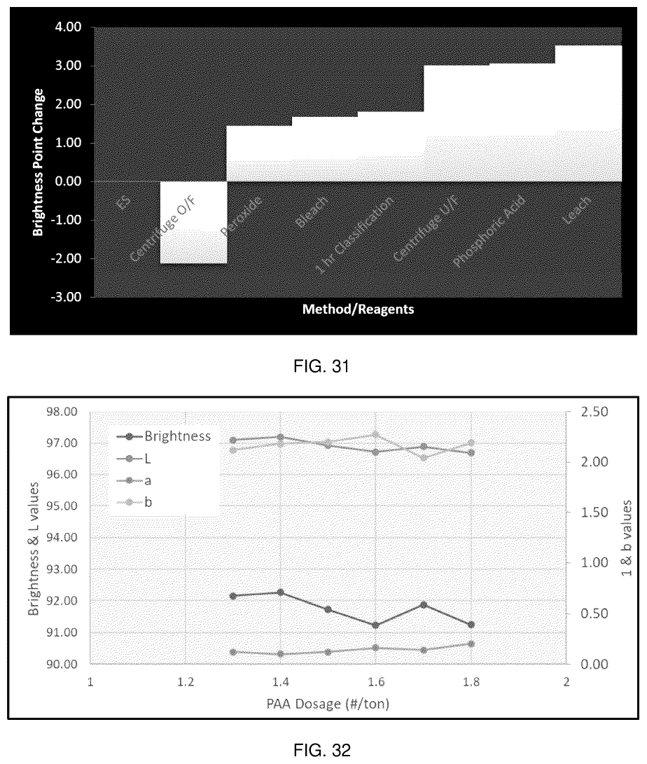

It was determined that acid addition/pH changed the way the material filtered. Exploration of how acid affects filtration is needed—shown in Table 17 and FIG. 31.

TABLE 17

| Method & | | | Point | |
|---|---|---|---|---|
| Reagent | Conc. % | Brightness | Change | Notes |
| ES | 10 | 83.11 | 0.00 | NFF |
| Centrifuge O/F | | 81.00 | −2.11 | 7 min at 70 & NFF |
| Peroxide | 35 | 84.54 | 1.43 | 2#/Ton & NFF |
| Bleach | 7 | 84.77 | 1.66 | 4#/Ton & NFF |
| 1 hr Classification | | 84.91 | 1.80 | NFF |
| Centrifuge U/F | | 86.11 | 3.00 | 7 min at 70 & NFF |
| Phosphoric Acid | 10 | 86.16 | 3.05 | FF |
| Leach | 85 | 86.63 | 3.52 | 2#/Ton & FF |

*FF = Filtered and Floc'd
*NFF = Not floc'd and filtered

### Initial Peracetic Acid (PAA) Trials—Effects on Brightness

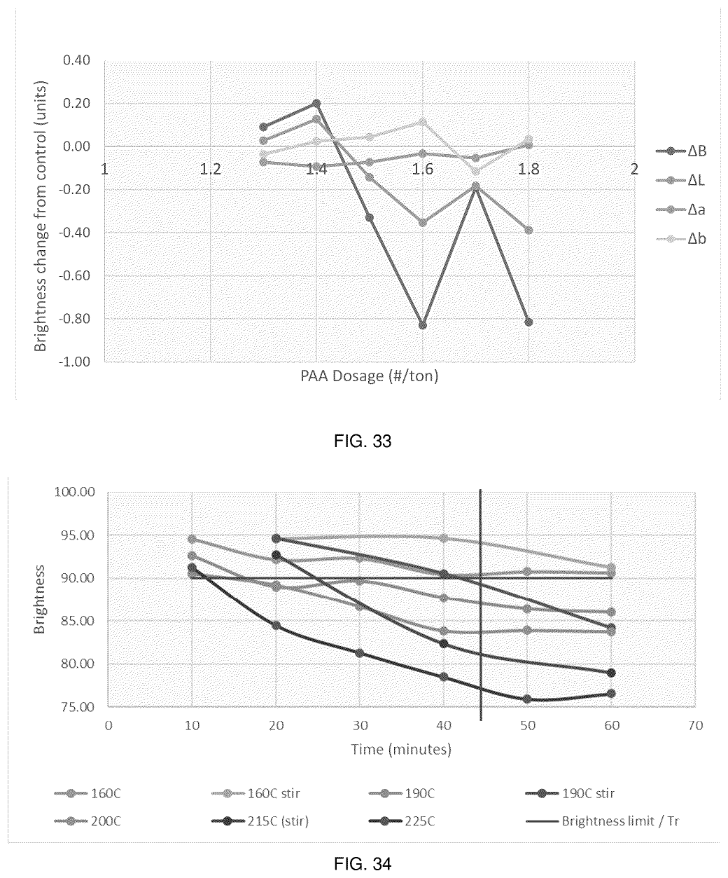

The results of the sterilization effects of PAA to brightness are shown in FIGS. 32 and 33. The effects did not seem to follow a clear trend, but the changes were less than 1 brightness unit and all overall brightness values were >90.

### Temperature Profile for Heat Sterilization—2

The effects of static heat sterilization with agitation are shown in FIG. 34. For calciner drying trials planned, ECT BioMinerals target >20-minute retention time for sterility and between 150° C.-180° C. for maintenance of brightness >90.

### Example 4

### Stage IV—Filtration/Drying

### Effects of pH Adjustment on Filtration: Purpose—to Further Understand the Effect Acid Addition has on the Ease of Filtration for Calcium Carbonate Product.

A Buchner funnel with a Whatman #1 filtering setup with a sidearm is used to observe flocculation at specific pH levels. Flocculation success is determined by the presence or absence of what material in the flask (what went through the filter). All pH adjustments were made with 10% phosphoric acid. Results are shown in Table 18 below.

TABLE 18

| | Complete | |
|---|---|---|
| Final | flocculation | |
| pH | achieved? | Notes |
| 8.46 | No | Starting pH (no acid added) |
| 7.10 | No | |
| 6.91 | No | |
| 6.60 | No | |
| 6.45 | No | Some material being retained on filter, |
| | | most going through |
| 6.35 | No | Better than 6.45, but not complete |
| 6.00 | Yes | Complete flocculation; underflow clear |

It was determined that the reaction that is occurring with the addition of acid is complete at pH 6 and causes the material to mimic the flocculation process of kaolin, making vacuum filtration a viable way to dewater this calcium carbonate material. This acid-assisted flocculation is termed “nano-etching”.

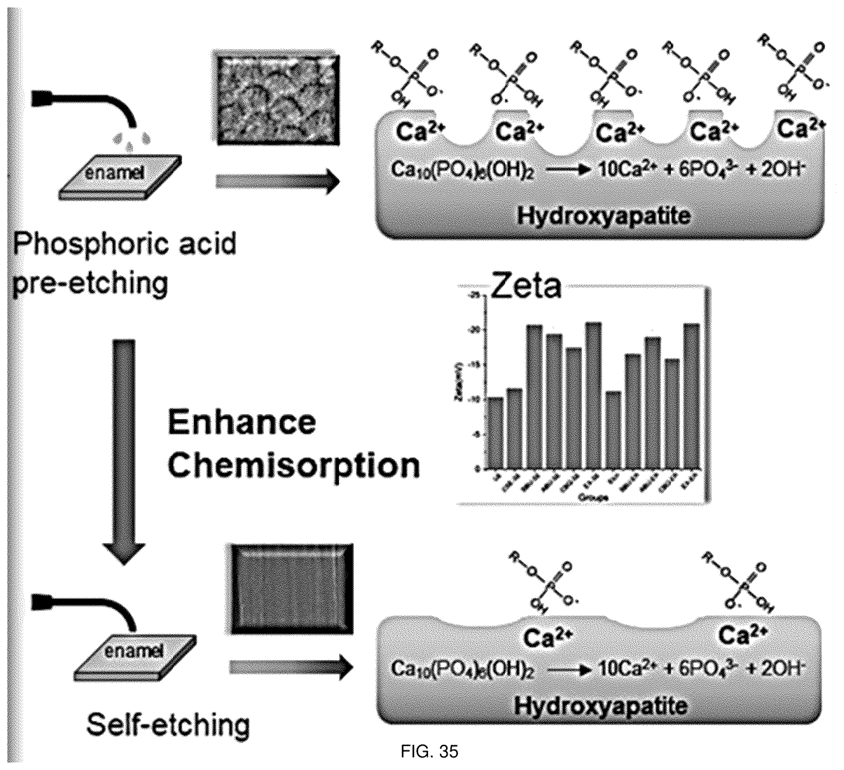

### The Science and Application of Nano-Etching (FIG. 35)

### Improved Dewatering and Filtration Kinetics

Diffusion and Tortuosity in Porous Functionalized Calcium Carbonate [2015] Levy, Charlotte L.; Matthews, G. Peter; Laudone, Giuliano M.; Gribble, Christopher M.; et al. “Calcium carbonate can be functionalized/surface modified by use of etching agents such as phosphoric acid to create inter- and intraparticle porosity with a range of morphologies. It is shown that the primary particle size of a sample was a better predictor of Da² calculated from the experimental diffusion curves, and also of the porosity-scaled tortuosity values, than the porosity or surface area. There was also a correlation between intraparticle tortuosity, scaled by porosity, and diffusion coefficient.”

### Wet Grinding Trials Continued:

Re-perform last wet grinding trial with the updates below and re-evaluated post-grind sequential processing options on brightness.

RECIPE
50% solids solution of <50 mesh hammer-milled eggshells
1.4:1 1 mm zirconia beads to eggshell solutions
2 #/ton dispersant (4306)
1 hour grind

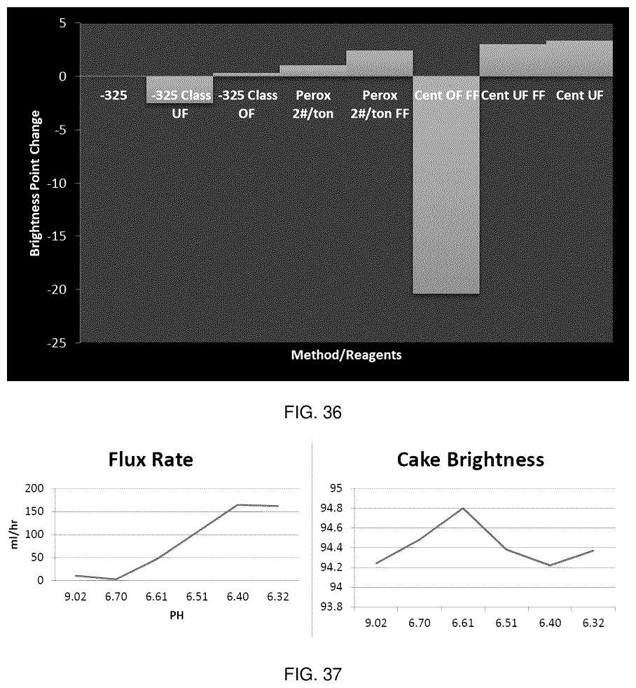

Classification and Brightness results are shown in Tables 19 and 20 below and in FIG. 36.

TABLE 19

| | PSD |
|---|---|
| Sample | (% <2 um) |
| −325 | 65 |
| −325 class OF | 74.1 |
| ES6Z. 1-2 CF UF | 65.6 |
| ES6Z. 1-2 CF OF | 97.5 |

TABLE 20

| | | Point | | | |
|---|---|---|---|---|---|
| Sample | TAPPI | Change | L | a | b |
| −325 | 82.76 | 0 | 92.45 | 0.42 | 2.62 |
| −325 Class UF | 80.23 | −2.53 | 91.34 | 0.3 | 3.01 |
| −325 Class OF | 83.05 | 0.29 | 92.56 | 0.41 | 2.54 |
| −325, Perox 2#/ton | 83.80 | 1.04 | 92.88 | 0.42 | 2.42 |
| −325, Perox 2#/ton FF | 85.20 | 2.44 | 93.57 | 0.36 | 2.33 |
| Cent OF FF | 62.36 | −20.4 | 81.48 | 0.22 | 4.11 |
| Cent UF FF | 85.80 | 3.04 | 93.81 | 0.33 | 2.21 |
| Cent UF | 86.13 | 3.37 | 93.96 | 0.35 | 2.16 |

*FF = Filtered and Floc'd
*NFF = Not floc'd and filtered

It was determined that Classification, peroxide treatment/acid treatment and centrifugation had increasing brightness effects on the product. The centrifuge overflow material reached a particle size of >90%<2 μm. 100%<325 mesh off the grind was still not achieved.

Filter Flux Rate Trial—Based on the acid-assisted flocculation (“nano etching”), this experiment seeks to determine how filter rates and brightness is affected.
Cal-X 15W material used
200 g samples (B=92.6) treated with 1% Phosphoric acid and filtered at target pH ranges of 6.3-6.7

Results shown in Table 21 below and FIG. 37.

TABLE 21

| | | | | | Wet | Dry | Dry | | | | | |
|---|---|---|---|---|---|---|---|---|---|---|---|---|
| | | | | Volume | Weight | Weight | Weight | | | | | |
| | Acid | Time | | of | of | of | of | | | | | |
| | added | to | | filtrate | Filtrate | filtrate | Cake | Flow Rate | Cake | | | |
| PH | (ml) | Cake | | (ml) | (g) | (g) | (g) | (ml/hr) | Brightness | L | a | b |
| 9.02 | 0 | 13.87 | 6.67 | 142 | 149 | 14.9 | 26.6 | 10.2 | 94.24 | 97.2 | 0.18 | 0.69 |

| | | | | | | | | | | | |
|---|---|---|---|---|---|---|---|---|---|---|---|
| 6.70 | 16 | 48.37 | 116 | 117.6 | 1.3 | 39.8 | 2.4 | 94.48 | 97.18 | 0.23 | 0.49 |
| 6.61 | 21 | 3.28 | 150 | 152.4 | 0.55 | 39.8 | 45.7 | 94.8 | 97.18 | 0.21 | 0.61 |
| 6.51 | 21 | 1.43 | 150 | 152.1 | 0.5 | 40.6 | 104.7 | 94.38 | 97.23 | 0.2 | 0.63 |
| 6.40 | 27 | 0.95 | 156 | 156.6 | 0.55 | 41.1 | 164.2 | 94.22 | 97.17 | 0.2 | 0.66 |
| 6.32 | 35 | 0.97 | 156 | 157.5 | 0.62 | 39.2 | 161.4 | 94.37 | 97.23 | 0.21 | 0.64 |

It was determined that acid-treatment to pH of 6.6 gives optimum filtration rate and brightness.

Product Finalization At first, the final products were oven dried and pulverized, but Hegman Grind testing showed nibs were still present. To ensure the best possible paint test results (which requires a fine particle size), replicate batches were wet ground and spray dried.

The further shortened acronym “COW” is used in place of Cal-Ox-W (White eggshells, peroxide treated) and “COWA” in place of Cal-Ox-W, Acid-treated. (White eggshells, peroxide and acid treated).

The final spray-dried products and their properties are found in Table 22.

TABLE 22
Physical Properties

| | C.O.W. | C.O.W.A. |
|---|---|---|
| Physical Form | Spray Dried | Spray Dried |
| | White Powder | White Powder |
| GE Brightness (%) | 88.99 | 90.24 |
| Screen Residue 325 Mesh(%) | 0.001 | 0.005 |
| Free Moisture (%) measured at 40° C. | 0.82 | 1.17 |
| pH (20% Solids) | 9.65 | 8.04 |
| Median Particle Size, Sedigraph (um) | 1.372 | 1.372 |
| Percent <2 um, Sedigraph | 98.1 | 97.6 |
| Density (g/cm³) | 2.5 | 2.5 |
| Bulk Density, Loose lbs./ft³) | 50.2 | 46.7 |
| Bulk Density, Tapped lbs./ft³) | 54.4 | 51.2 |
| Lol @ 1000° C. | 45.55 | 44.8 |
| Oil Absorption | 60.56 | 60.56 |

Observations: 1) A 50:50 ratio of 1 mm: 3 mm beads overgrinds, 2) Using all 3 mm beads increases recovery but doesn't grind enough, 3) Some ratio between the 2, e.g., 1:4 (small:large) was used.

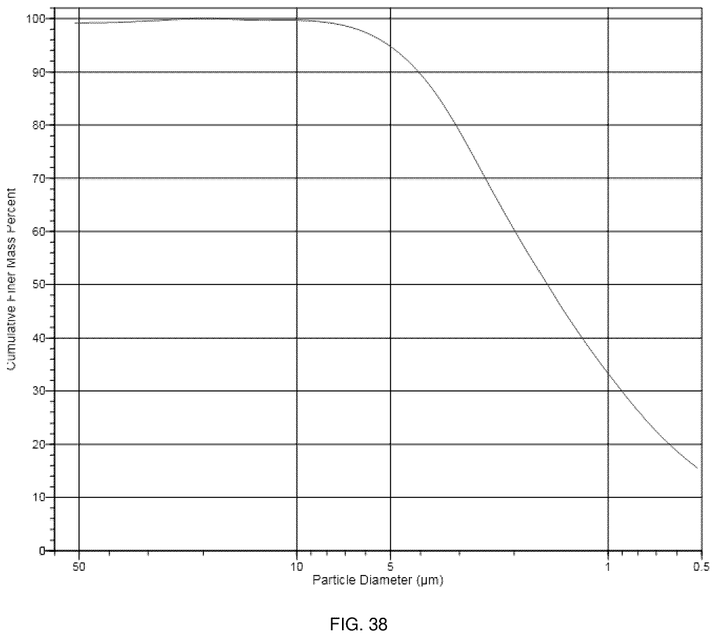

Grind Trials on ˜19.5 lb of shells recovered during “Final Grind” runs. The Bead ratio used was 1:4 (small 1 mm beads:large 3 mm beads). Due to lack of material and required volume for grinding pot, the solution was reduced to 31.86% solids. 2 #/ton BCS4306 dispersant was used to grind at original 24.1 Hz in 5-minute intervals to be conservative considering these shells had experience some prior processing and we didn't want to overshoot the particle size target. The 20- and 35-min tests showed very different almost bimodal curves, which disappeared when additional dispersant was added. 5 #/ton was required to see consistent results. The updated dosage requirement is 35 minutes required to see full recovery <325 mesh. Using the confirmed, dispersed data, the theoretical additional grind time required to reach desired particle size range is 36.5 min—shown in FIG. 38. The final test point of 77 min produced a d50=1.663 μm and 60.3%<2 μm. Batch grinding was performed to produce the required amount of sample for plastics application testing at the required d50 particle size (1.4-1.7 μm). The initial material was spray dried and the option of low temperature oven drying (95° C.) and pulverization (requires no nibs) was evaluated.

RECIPE
60% solids of cleaned, de-membraned shells
1:4 ratio of small (1 mm) to large (3 mm) beads
No dispersant (moved peroxide step to beginning of process, so it won't be able to remove it after the grind)
55-minute grind

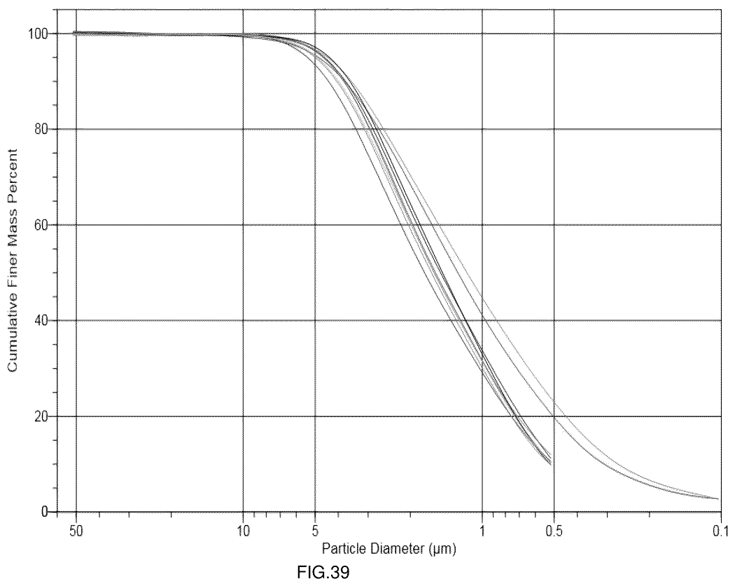

This produced material within the desired particle size range that was then spray dried successfully. However, spray drying is time consuming, so some of the material was low-temperature oven dried and double pulverized. This method also produced a particle size within the specified range. Subsequent Hegman grind analysis showed that the oven-dried, pulverized product performed similarly to the control material, so the decision was made to stay with this method in the interest of time, but both methods are equally successful. FIG. 39 shows a particle size overlay of all the processed batches for comparison.

### Example 5

### Stage V—Product Forms/Storage/Distribution/Shipping for BioMaterials, BioResources, BioFillers, BioCoatings, BioPreCursors, Nano-BioFillers and BioCoatings

Initial Products for Paint Testing: Purpose—The same process as outlined above was recreated with both white and brown OES for final production of paint application samples. A total of (4) samples were created: Peroxide treated, peroxide & acid treated white and brown shells, respectively. The results are shown in Table 23.

TABLE 23

| | Brightness | L | a | b |
|---|---|---|---|---|
| Brown | | | | |
| Peroxide | 88.27 | 95.1 | 0.22 | 2.25 |
| P-Acid | 90.47 | 95.92 | 0.24 | 1.73 |
| White | | | | |
| Peroxide | 92.4 | 96.57 | 0.13 | 1.16 |
| P-Acid | 93.93 | 97.01 | 0.2 | 0.65 |

Paint Application Results—The samples were compounded into a semi-gloss acrylic paint formula and compared to ultrafine calcium carbonate (Omyacarb UF) at equal weight percent loading levels.

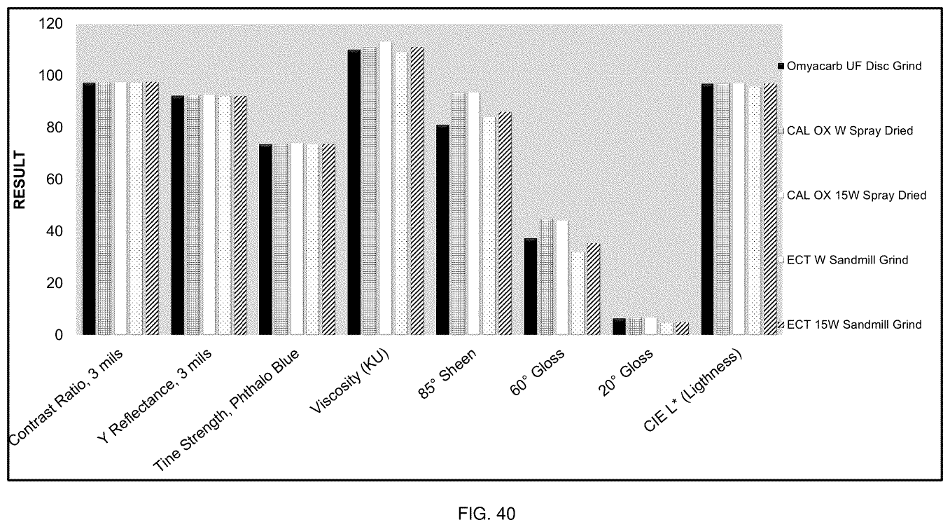

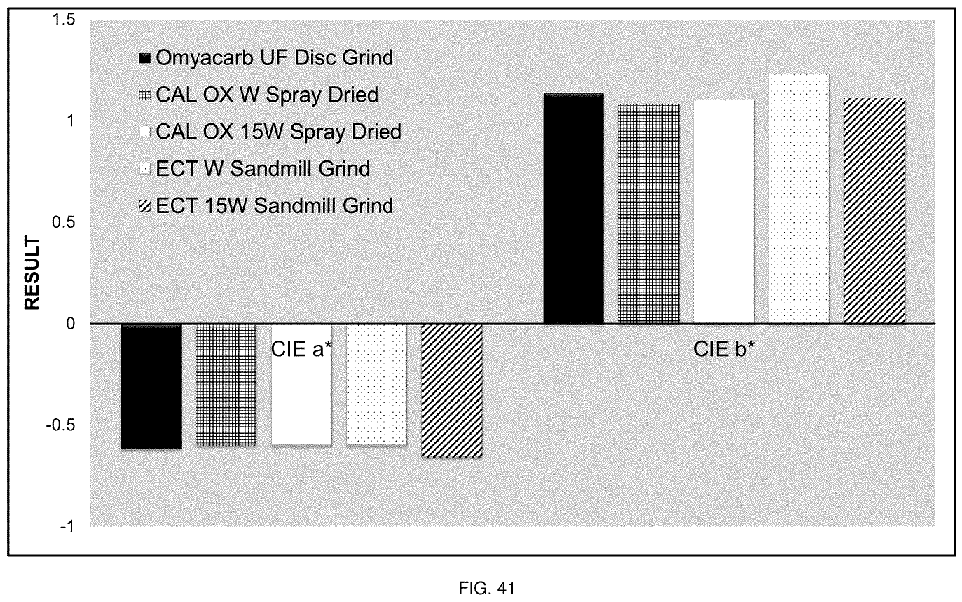

GMT's samples performed equal to or above the level of a commercial-available calcium carbonate currently used in paint formulation. FIGS. 40 and 41 reveal the results.

### Plastics Application Results

It is known that the plastic industry coats their calcium carbonate in stearic acid prior to use in a formulation. GMT procured stearic acid for coating via high-energy mixing and confirmed complete coating using water separation and acid addition methods.

The coated material is used in plastics formulations to determine how well it performs against commercially available calcium carbonates.

ECT BioMinerals' first trial product was tested by a leader in the plastics industry for comparability to typically sourced calcium carbonate. They produced a concentrate at 70% loading and let it down into film at 15% and 30% for comparisons. The instruments used were: TGA TA Instruments TGA 550 Hi-Def Scan at 40° C./min to 525° C.; DSC: TA instruments DSC heat/cool/heat 35.0° C. to 190° C. at 10.0° C./min, hold temperature for 2 minutes at end of each ramp; Particle size: Micrometrics Saturn DigiSizer II high-definition digital particle size analyzer; Elmendorf: Thwing Albert ProTear® Electronic Tear Tester; and Tensile: Instron 3365 5 kN; ASTM D882.

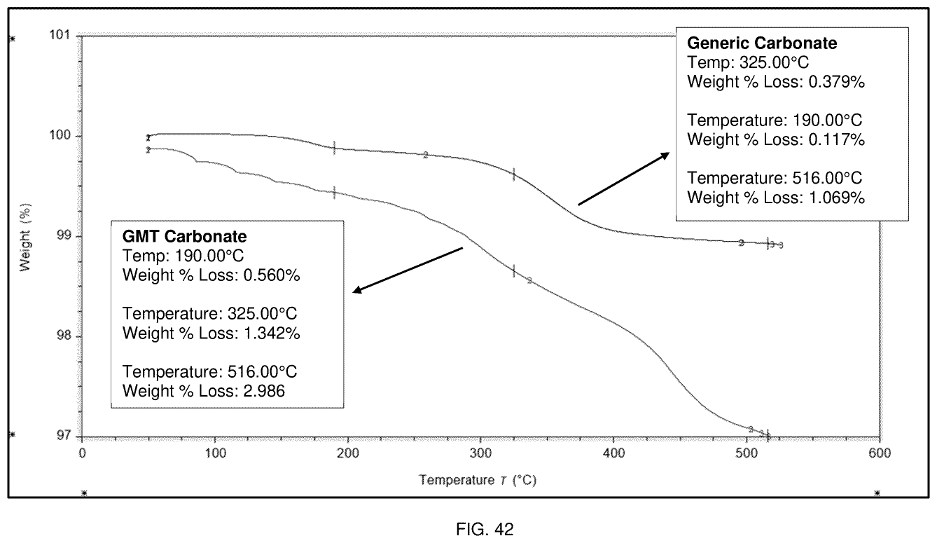

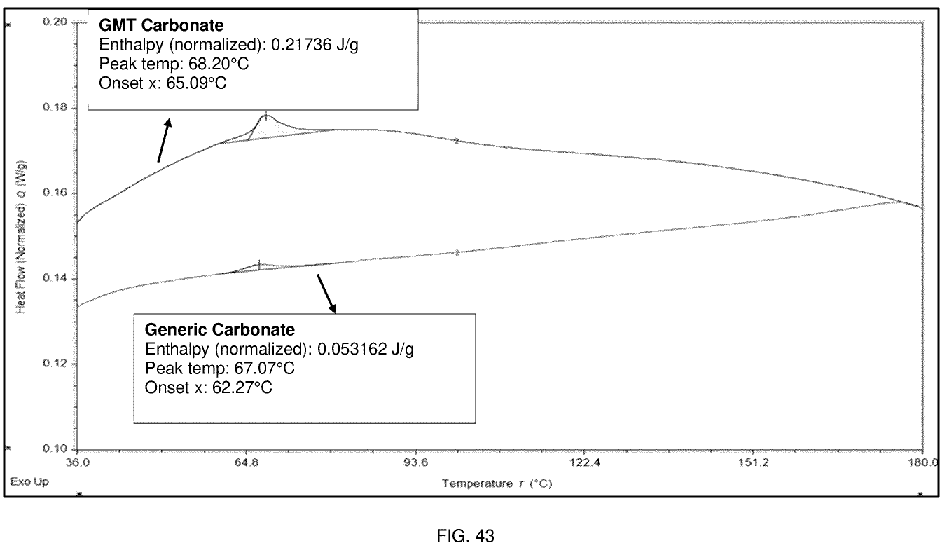

FIG. 42 shows the TGA overlay of GMT-RCarbonate (ECT BioMinerals' biocarbonate from eggshells) and generic calcium carbonate. FIG. 43 shows the DSC overlay of GMT-RCarbonate and generic calcium carbonate.

The particle size data for GMT-RCarbonate is shown in Table 24.

TABLE 24

| | | | | | | | |
|---|---|---|---|---|---|---|---|
| Low Particle | Cumulative | Low Particle | Cumulative | Low Particle | Cumulative | Low Particle | Cumulative |
| Diameter | Volume Finer | Diameter | Volume Finer | Diameter | Volume Finer | Diameter | Volume Finer |
| (μm) | Percent | (μm) | Percent | (μm) | Percent | (μm) | Percent |

Report by Size Table

| | | | | | | | |
|---|---|---|---|---|---|---|---|
| 10.000 | 98.8 | 2.000 | 46.1 | 1.000 | 21.9 | 0.100 | 2.2 |
| 5.000 | 87.9 | 1.500 | 34.8 | 0.500 | 10.6 | | |

Report by Volume Percent

| | | | | | | | |
|---|---|---|---|---|---|---|---|
| 16.269 | 100.0 | 5.307 | 90.0 | 2.195 | 50.0 | 0.461 | 18.0 |
| 8.796 | 98.0 | 3.421 | 70.0 | 1.311 | 30.0 | | |

The particle size data for generic calcium carbonate is shown in Table 25.

TABLE 25

| | | | | | | | |
|---|---|---|---|---|---|---|---|
| Low Particle | Cumulative | Low Particle | Cumulative | Low Particle | Cumulative | Low Particle | Cumulative |
| Diameter | Volume Finer | Diameter | Volume Finer | Diameter | Volume Finer | Diameter | Volume Finer |
| (μm) | Percent | (μm) | Percent | (μm) | Percent | (μm) | Percent |

Report by Size Table

| | | | | | | | |
|---|---|---|---|---|---|---|---|
| 10.000 | 98.9 | 2.000 | 54.5 | 1.000 | 23.7 | 0.100 | 2.6 |
| 5.000 | 97.9 | 1.500 | 38.3 | 0.500 | 11.7 | | |

Report by Volume Percent

| | | | | | | | |
|---|---|---|---|---|---|---|---|
| 13.689 | 100.0 | 3.566 | 90.0 | 1.861 | 50.0 | 0.410 | 10.0 |
| 5.051 | 98.0 | 2.511 | 70.0 | 1.227 | 30.0 | | |

The Elmendorf Tear Test Results Comparison between generic calcium carbonate and GMT-RCarbonate (biocarbonate) is shown in Table 26.

TABLE 26

| | Average tear | Standard |
|---|---|---|
| Sample | strength (gf) | deviation |
| Control 15 MD | 80.96 | 11.98 |
| Eggshell Max 15 MD | 131.2 | 16.96 |
| Control 15 TD | 344.64 | 24.37 |
| Eggshell Max 15 TD | 310.08 | 28.04 |
| Control 30 MD | 85.12 | 16.68 |
| Eggshell Max 30 MD | 65.6 | 19.74 |
| Control 30 TD | 324.06 | 47.60 |
| Eggshell Max 30 TD | 350.4 | 41.81 |

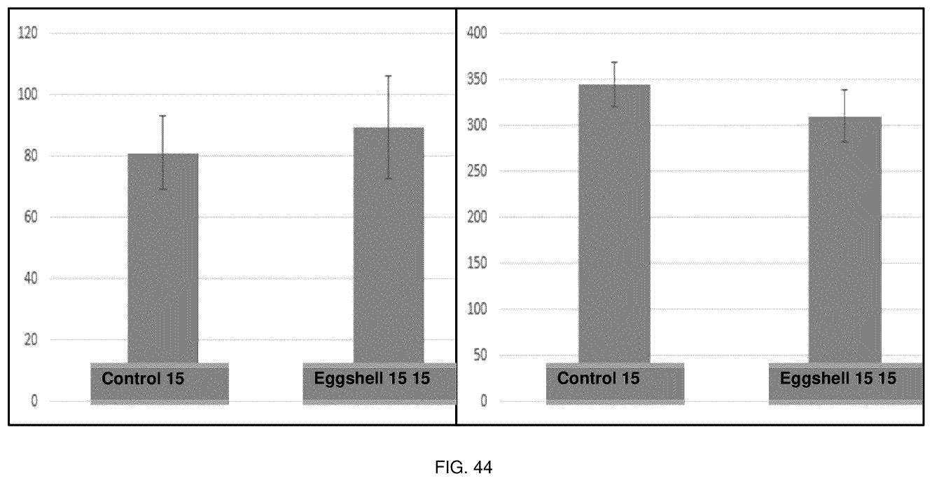

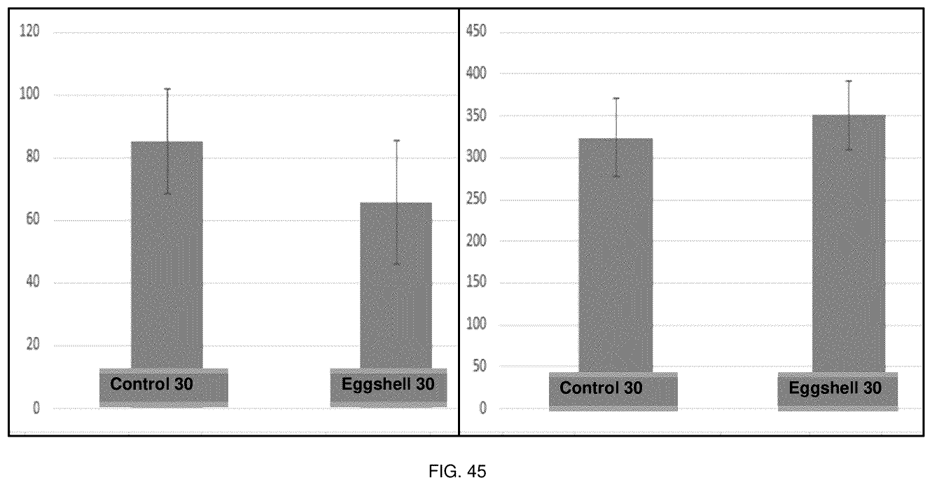

The tear results comparison at 15% and 30% let down are shown in FIGS. 44 and 45. The tensile data comparison is shown in Table 27.

TABLE 27

| | Tensile | | | |
|---|---|---|---|---|
| | strength at | Standard | Modulus | Standard |
| Sample | yield (psi) | Deviation | (psi) | Deviation |
| Control 15 MD | 2813 | 524.42 | 283223 | 106038 |
| Eggshell Max 15 MD | 2358 | 121.05 | 257288 | 12409 |
| Control 15 TD | 2450 | 163.4 | 254689 | 5563 |
| Eggshell Max 15 TD | 2197 | 290.38 | 259627 | 13196 |
| Control 30 MD | 2560 | 177.12 | 254543 | 6077 |
| Eggshell Max 30 MD | 2519 | 271.16 | 256749 | 7670 |
| Control 30 TD | 2299 | 228.11 | 251367 | 8172 |
| Eggshell Max 30 TD | 2296 | 353.6 | 259352 | 10374 |

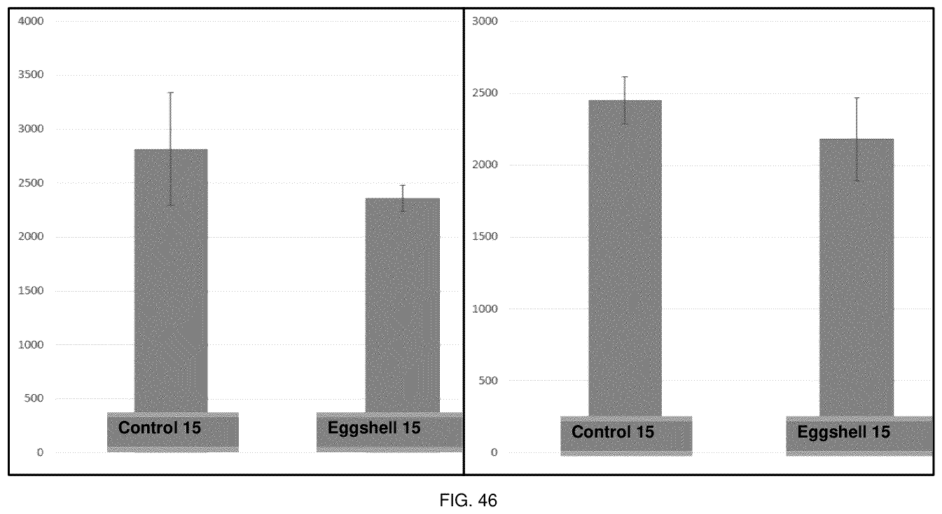

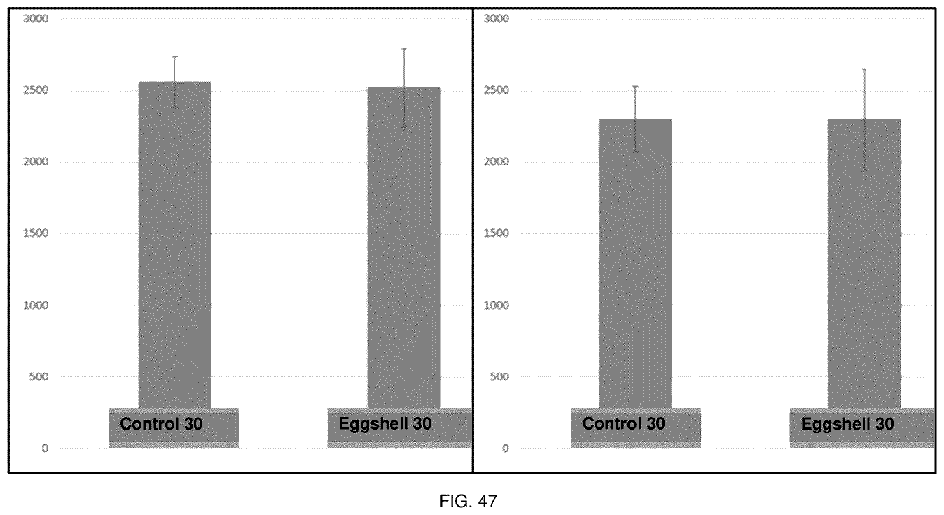

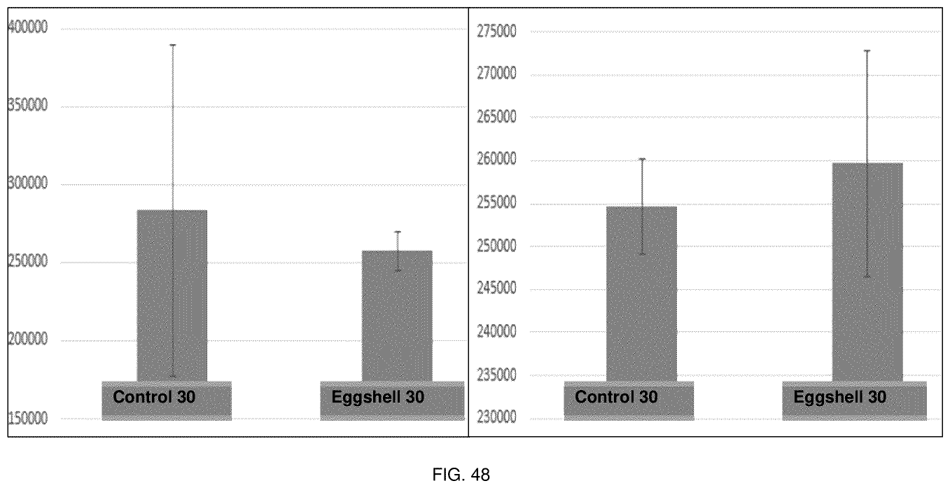

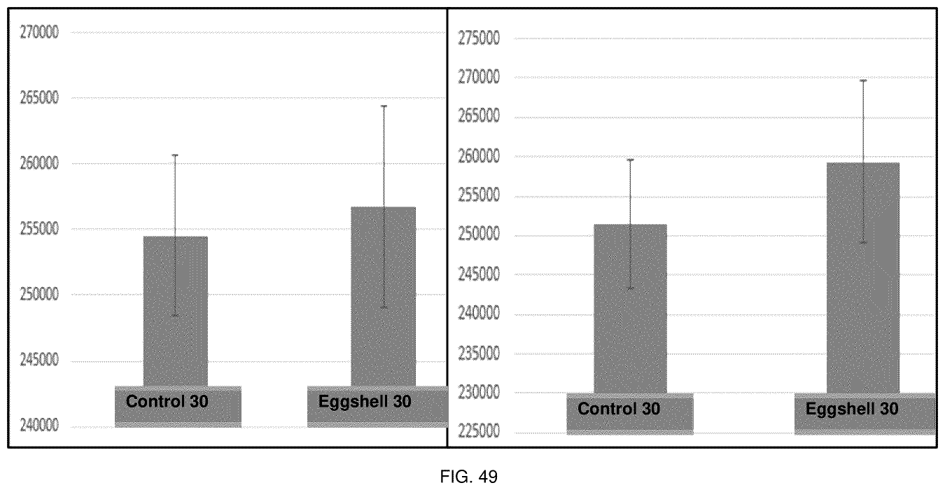

The tensile strength at yield comparison between the two at 15 and 30% let down is shown in FIGS. 46 and 47. The Modulus comparisons at 15 and 30% let down are shown in FIGS. 48 and 49.

Results: Odor was present and should be addressed, but performance is acceptable. Coating level or level of impurities should be addressed (see TGA overlay compared to typical fatty acid treated calcium carbonate for reference of low molecular weight materials). DSC can be referenced to compare treatment level of the eggshell calcium carbonate to standard fatty acid treated calcium carbonate (eggshell material appeared to have a higher level of free fatty acid, and thus the treatment level can most likely be further optimized). No issues were found in particle size data compared to the standard calcium carbonate. Film properties are within standard deviation of film properties of typical composition, and in some instances outperformed the typical composition. Of note, the eggshell calcium outperformed the standard calcium in machine direction tear strength.

The various embodiments are provided by way of example and are not intended to limit the scope of the disclosure. The described embodiments comprise different features, not all of which are required in all embodiments of the disclosure. Some embodiments of the present disclosure utilize only some of the features or possible combinations of the features. Variations of embodiments of the present disclosure that are described, and embodiments of the present disclosure comprising different combinations of features as noted in the described embodiments, will occur to persons with ordinary skill in the art. It will be appreciated by persons with ordinary skill in the art that the present disclosure is not limited by what has been particularly shown and described herein above. Rather the scope of the disclosure is defined by the appended claims.

What is claimed is:

1. A biomaterial comprising biocarbonates and/or biominerals obtained from a bioresource comprising avian eggshells, snail shells, oyster shells, or seashells.

2. The biomaterial of claim 1, wherein the biocarbonate comprises calcium carbonate (CaCO₃) in about 95-97% range, wherein the calcium carbonate shows different morphologies from natural resource carbonates, and with a brightness ranging from about 88-97.

3. The biomaterial of claim 2, wherein particle size of the calcium carbonate is customizable to range as far down as 90%<2 μm to nano scale.

4. The biomaterial of claim 1, wherein the biocarbonates and/or biominerals are substitutes of natural resource carbonates for catalysts, nano reactors, drug delivery, bioceramics, biomaterial precursors, plastics, papers, fillers, paints, and/or coatings.

5. The biomaterial of claim 1, wherein the biocarbonates are used for paints, coatings, papers, and/or plastics.

6. The biomaterial of claim 5, further comprising pigments and fillers consisting of hydrous fillers, anhydrous fillers, and functional fillers.

7. A method of producing the biomaterial of claim 1, comprising:
(1) sorting and blending the biomaterial comprising biocarbonates and/or biominerals obtained from a bioresource comprising avian eggshells, snail shells, oyster shells, or seashells,
(2) separating and removing the albumin and/or membrane from the shells,
(3) sterilizing and eliminating odor from the shells, and
(4) processing and producing a final product comprising biocarbonates and/or biominerals for multiple end-uses/applications.

8. The method of claim 7, wherein separating the membrane from the shells is through an autogenous grinding step, wherein the shells are reduced in size and membranes are effectively liberated and separated by floating via density differences.

9. The method of claim 8, wherein chemicals can be used in aiding the autogenous grinding.

10. The method of claim 7, wherein separated albumin and/or membrane is recovered for other product streams while simultaneously recycling wastewater.

11. The method of claim 7, wherein sterilizing and eliminating odor is performed by using bleach, sodium hydrosulfite, hydrogen peroxide, biocide, acetic acid, strong acids, acetone, ammonia, or ozone.

12. The method of claim 7, wherein application-specific to nano-etch the biomaterial is performed for effectively be flocculated for improved filtration efficiency and drying.

13. The method of claim 7, wherein applications-specific to soft-drying, pulverizing and/or hard drying steps are performed for further processing.

14. The method of claim 7, wherein the dried biomaterial is surface coated for application-specific needs.

15. The method of claim 7, wherein further brightness processing is performed to improve overall brightness.

16. The method of claim 15, wherein the brightness process comprises bleaching, leaching, and/or thermal processing with carbonation.

17. The method of claim 16, further comprising particle sizing and/or coating as an end use application requires.

18. The method of claim 17, wherein the final product obtained comprises calcium carbonate (CaCO₃) in about 95-97% range, wherein the calcium carbonate shows different morphologies from natural resource carbonates, and with a brightness ranging from about 88-97.

19. The method of claim 18, wherein particle size of the calcium carbonate is customizable to range as far down as 90%<2 μm to nano scale.

20. The method of claim 19, wherein the biocarbonates are substitutes of natural resource carbonates for plastics, papers, fillers, paints, and/or coatings.
